(19) United States
(12) Patent Application Publication
(10) Pub. No.: US 2016/0242450 A1
(43) Pub. Date: Aug. 25, 2016

(54) Functional-gel Compositions and Methods

(71) Applicant: Rey Magana, Temecula, CA (US)

(72) Inventor: Rey Magana, Temecula, CA (US)

(21) Appl. No.: 14/866,944

(22) Filed: Sep. 26, 2015

Related U.S. Application Data
(60) Provisional application No. 62/030,192, filed on Jul. 29, 2014.

(51) Int. Cl. A23L 1/308; A23L 1/0562; A23L 1/29

(52) U.S. Cl. CPC A23L 1/308; A23L 1/293; A23L 1/05625; A23V 2002/00

(57) ABSTRACT

The present invention relates to functional-gel compositions as medicaments, foods, food ingredients, food supplements and to uses and methods. The functional-gels comprise an edible gelling agent and additionally a dietary protein or a dietary fiber or a combination of both. The functional-gel compositions when consumed in a sufficient amount as a supplement to a diet, meal or snack promote satiety and reduce energy intake in a subject in need thereof. The functional-gels are useful for improving weight management and promoting health. The functional-gels are useful for the treatment or prevention of over-weight, obesity and related conditions in a subject in need thereof. The functional-gel compositions may be formulated in a variety of ways to provide acceptable taste and texture, including for example as health bars, confections or as ready-to-eat, ready-to-drink, shelf stable and single-serve packaged foods.

### RELATED U.S. APPLICATION DATA

Provisional application No. 62/030,192, filed on Oct. 1, 2014.

### FIELD OF THE INVENTION

The present invention relates to nutrition generally and specifically to compositions, uses and methods for inducing satiety and weight management.

### BACKGROUND OF THE INVENTION

Overweight, obesity and metabolic syndrome are the fastest growing segments of unmet medical need with over 75% of adults in the United States suffering from overweight or obesity and 24% with Metabolic Syndrome. Obesity is estimated to contribute to 50% of chronic diseases and to about 70% of preventable deaths. Obesity is associated with high risk for co-morbidities including heart disease, hypertension, stroke, arthritis, some forms of cancer and type 2 diabetes. Metabolic Syndrome, according to the American Heart Association, is a group of risk factors including insulin resistance, impaired glucose tolerance, hypercholesterolemia, hypertension and abdominal obesity which double a person's risk of cardio vascular disease and increases the risk of diabetes by five fold. Overweight and obesity are multi-factorial conditions, but at the core they originate from an energy imbalance; more specifically, an energy surplus that is created by energy intake that exceeds energy expenditure. In other words most individuals become overweight because they consume more calories than they burn resulting in an over accumulation of body fat. It is reported that daily caloric consumption increased by an average of 530 calories between 1970 and 2000. The data also suggest that, people either eat more or eat higher calorie foods—or both. On the bright side, it is known that overweight and obesity-related conditions are significantly improved with even modest weight loss of between 5% to 10%; even when many individuals remain considerably overweight [International Textbook of Obesity. Edited by Per Bjorntorp.Copyright © 2001 John Wiley & Sons Ltd]. It is also reported that a modest reduction of 200 calories per day can lead to health benefits. [Diet, Nutrition and the Prevention of Chronic Diseases Report of the Joint WHO/FAO Expert Consultation, World Health Organization Geneva 2003]. Despite the clear benefits that can be gained from even modest weight loss it is clear from the alarming rise in global rates of overweight and obesity that available interventions such as pharmaceuticals, surgical procedures and the adoption of a multitude of dieting and exercise regimens by the populace have been insufficient. A need exists for safe and unrestricted approaches that facilitate and promote lower caloric intake that can lead to weight management, weight loss and the promotion of health.

### Non Limiting Statements

Tittles and subtitles used herein, unless necessitated by statutory requirement, are only for reference purposes and are not intended to limit the scope of the present invention. Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques. Notwithstanding the fact that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. For example, a disclosure of a range of 1 to 10 should be considered to provide support in the specification and claims to any subset in that range (i.e., ranges of 2-9, 3-6, 4-5, 2.2-3.6, 2.1-9.9, etc.). In addition, the terms “one,” “a,” or “an” as used herein are intended to include “at least one” or “one or more,” unless otherwise indicated. Any patent, publication, or other disclosure material, in whole or in part, that is identified herein is incorporated by reference herein in its entirety, but is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. When the term “included” is used herein, unless otherwise specified, the term should be interpreted to mean the same as “including but not limited to”. When the term “a functional-gel including gelatin” is used, unless otherwise specified the term should be interpreted to mean “a functional-gel including a function gel comprising gelatin”

The present disclosure provides various features and aspects of the exemplary embodiments pro vided herein. It is understood, however, that the present disclosure embraces numerous alternative embodiments, which may be accomplished by combining any of the different features, aspects, and embodiments described herein in any combination that one of ordinary skill in the art may find useful.

### BRIEF SUMMARY OF THE INVENTION

The present invention relates to functional-gel compositions as medicaments, foods, food ingredients, food supplements, uses and methods. The functional-gel compositions of the invention comprise a gelling agent and additionally at least a dietary protein or at least a dietary fiber. Alternatively the functional-gels of the invention comprise a gelling agent and additionally a combination of a dietary protein and a dietary fiber. The functional-gels of the invention when consumed as a supplement to a diet, meal or snack in sufficient quantities are useful for promoting satiety and reducing energy intake in a subject in need thereof.

Furthermore the functional-gels of the invention are useful for the promotion of body weight management for example by reducing or preventing weight gain or by promoting weight loss in a subject in need thereof. The functional-gels are useful as treatments or as interventions for conditions such as overweight or obesity. The functional-gels of the invention are also useful to promote health by preventing or treating co-morbidities associated with overweight and obesity for example but not limited to cardiovascular disease, diabetes and metabolic syndrome in a subject in need thereof.

The sufficient quantity of functional-gel consumed to promote satiety and reduce energy intake will vary according to an individual's need, however the quantity of functional-gel consumed shall be sufficient to replace or substitute at least a portion of the subject's diet, meal or snack. The diet, meal or snack may be reduced by from 2% to 50% or more and preferable from 10% to 25% by weight.

To achieve best utility, the caloric value of functional-gel or composition comprising functional-gel per the present invention, will be less than the caloric value attributable to the portion of the food, meal or snack that was reduced or was excluded, or is intended to be reduced or excluded as a result of consuming the functional-gel or composition comprising functional-gel. For example a meal that is subsequently reduced from 700 kcal to 400 kcal as a result of a subject consuming a 50 kcal functional-gel composition, results in a 300 kcal reduction in food intake for that meal. When accounting for the 50 kcal consumed from the functional-gel composition the net caloric reduction is 250 kcal, a 35.7% reduction in caloric intake for that meal. The Percent Energy Compensation in such a case would be equal to 600%, a significant overcompensation; ([(700−400)/50]×100=600%) In other words the subject will have reduced the caloric consumption of the meal by 6× the caloric contribution of the functional-gel composition.

The functional-gels of the invention are formulated with low-caloric density relative to the diet, meal, or snack that they replace and thereby result in reduced caloric intake. The functional-gel composition when in a hydrated form has a preferred caloric density equal to or less than 4 kcal/g and preferably equal to or less than 3 kcal/g and more preferably equal to or less than 2 kcal/g and most preferably equal to or less than 1 kcal/g. Hydration of the functional-gel may take place prior to ingestion by a subject or may take place after ingestion by a subject within the subject's gastrointestinal tract. Therefore provided the functional-gel is allowed to hydrate within the gastrointestinal tract it may be prepared and consumed in a dry powder form.

Surprisingly the inventor has found that functional-gel compositions of the present invention when consumed in sufficient quantity in association with a meal or snack leads to significant energy overcompensation. In other words the use of functional-gel compositions, in association with a meal or snack leads to a significant reduction in the portion size for that meal or snack and/or for the subsequent meal in an amount that can significantly exceed the caloric value of the functional-gel resulting in an overall reduction in caloric intake (energy intake). Stated another way, surprisingly the inventor has found that functional-gels of the present invention when formulated according to the disclosures herein and consumed by an animal or human subject in sufficient quantities in association with a diet, meal, or snack, generate similar fullness and satiety as compared to the diet, meal or snack alone (FIGS. 3, 4, 5) but with the benefit of energy compensation and weight loss. Surprisingly the inventor has also found that functional-gels of the present invention when formulated according to the disclosures herein and consumed by an animal or human subject in sufficient quantities in association with a diet, meal, or snack, generate significantly improved energy compensation and weight loss, compared to previous published reports employing preloads consisting of gelling agents alone, dietary proteins or dietary fibers or even combined macronutrient preloads.

Although, proteins, dietary fiber, and gelling agents such as gums and hydrocolloids, have been studied and have been reported to have satiety promoting properties their reported energy compensation levels, as a means to measure their ability to influence energy intake, in both preclinical and clinical settings has been very limited. For example Kirkmeyer et al in Int J Obes Relat Metab Disord. 2000 September; 24(9):1167-75 reported a percent energy compensation for peanuts of 104±24%; peanut butter of 151±33%; almonds of 57±25%; chestnuts of 57±40%; and chocolate of 89±37%. They also state that ANOVA indicated these values were not significantly different. The present invention provides superior satiety and superior energy compensation to other preloads when formulated as low-energy density compositions and when consumed in sufficient quantities in association with a diet, meal or snack generating for example experiments employing the functional-gels of the present invention resulted in an average % EC of 340% in an 8 wk human weight loss study (Table 1) and an average % EC of 414% in an acute satiety human study (Table 5).

The functional-gel compositions of the present invention or compositions comprising functional-gels, can be manufactured as nutritional supplements, food ingredients, foods, packaged foods and especially as a ready-to-eat, ready-to-drink, single serve, shelf stable packaged foods, snacks, and confections which by means of convenience and good taste will facilitate their use and increase compliance with a given diet program or regimen. Among contemplated products are for example nutritional bars, snack bars, gummy confections, meal replacements, gels, gelled drinks, shakes and smoothies. The compositions of the present invention or compositions comprising the present invention may be manufactured by any suitable means or method known and practiced in the food preparation, food processing, nutritional supplement or pharmaceutical industries among others. By way of example the present invention may be manufactured by methods used to produce dry, refrigerated, frozen or shelf stable products by means such as freezing, dehydration, acidification, aseptic fill, hot-fill, retort process, pasteurization, horizontal or vertical form fill seal processes, including high pressure treatment or other thermal, radiation, physical or chemical processing methods or combinations thereof.

### BRIEF DESCRIPTION OF DRAWINGS

FIG. 1 shows group mean body weights over a 30 day treatment period for mice maintained on high fat diets and administered either test articles (functional-gel composition of the invention) or controls (iso-caloric food) as pre-loads to their meals.

FIG. 2 shows group mean body weight change from baseline over a 30 day treatment period for mice maintained on high fat diets and administered either test articles (functional-gel composition of the invention) or control (iso-caloric food) as pre-loads to their meals.

FIG. 3 shows mean VAS (visual analog scale) results for hunger evaluations in human volunteers administered a functional-gel composition of the invention or an iso-caloric control as a pre-load prior a high caloric test meal.

FIG. 4 shows mean VAS (visual analog scale) results for Desire for Food evaluations in human volunteers administered a functional-gel composition of the invention or a isocaloric control as a pre-load prior a high caloric test meal.

FIG. 5 shows mean VAS (visual analog scale) results for Fullness evaluations in human volunteers administered a functional-gel composition of the invention or a isocaloric control as a pre-load prior a high caloric test meal.

### DETAILED DESCRIPTION OF THE INVENTION

The present invention relates to functional-gel compositions as medicaments, foods, food ingredients or food supplements and to uses and methods. The functional-gel compositions of the invention comprise a gelling agent and additionally at least a dietary protein or at least a dietary fiber. Alternatively the functional-gels of the invention comprise a gelling agent and additionally a combination of a dietary protein and a dietary fiber. The functional-gels of the invention when consumed as a supplement to a diet, meal or snack in sufficient quantities are useful for promoting satiety and reducing energy intake in a subject in need thereof.

The term subject includes companion animals and especially humans. The term protein refers to but is not limited to animal, plant, and fungal edible protein and especially hydrolyzed protein, hydrolyzed collagen, gelatin and amino acids. The term gelling agent refers to thickeners, gums and hydrocolloids from animal and non animal sources including plants. Gelling agent also refers to gelling or gelled proteins including but not limited to gelatin. Fiber refers to dietary fiber including for example functional fiber. The invention is hereafter referred to as functional-gel.

The invention further relates to uses of functional-gel compositions to promote fullness after a meal or snack. The invention further relates to uses of functional-gel compositions to reduce hunger. The invention further relates uses of functional-gel compositions to reduce food intake, caloric intake and energy intake. The invention further relates to uses of functional-gel for the promotion of weight loss and or for the management of body weight. The invention further relates to uses of functional-gel for the prevention, amelioration and treatment of conditions related to overweight, obesity and metabolic syndrome. Furthermore the present invention relates to uses of functional-gel as functional foods and as functional food ingredients. Furthermore the present invention relates to functional-gels which may be consumed directly or may be incorporated into foods, functional foods, beverages, supplements or medicaments. Furthermore the present invention relates to compositions comprising functional-gel including but not limited to confections, snacks, foods, supplements, food ingredients and food additives, including Ready To Eat (RTE), Ready To Drink (RTD) and ready mixes for example but not limited to gummies, meal replacements, nutritional bars, shakes and nutritional gels.

### Discovery

Surprisingly the inventor has discovered that functional-gel compositions when consumed in sufficient quantity in association with a meal or snack leads to significant overcompensation. In other words the use of functional-gel compositions, in association with a meal or snack leads to a significant reduction in the portion size for that meal or snack and/or for the subsequent meal in an amount that can exceed the caloric value of the functional-gel. Furthermore, the inventor has found that when functional-gel is used in sufficient amount as a supplement and in association with a meal or snack, satiety is increased, energy intake and hunger are reduced and weight loss is promoted. Importantly, these benefits are achieved irrespective of the macronutrient composition of the meal or diet. Furthermore, the effect is observed whether the diet is high protein or low protein and whether the protein source is singular or mixed. The effect is also observed whether the functional-gel is provided prior to a meal, as a snack between meals, with a meal or after a reduced calorie meal.

### Mechanism

The compositions and methods of the invention, are particularly effective at enhancing feelings of satiation and/or promoting satiety after ingestion, which without wishing to be bound by theory, is hypothesized to result from the fact that functional-gel compositions when hydrated provide a protein and/or a fiber source in combination with a gelling agent such as a gum or hydrocolloid in a low-calorie-density formulation, increasing the bulk and viscosity of a meal or snack consumed with the functional-snack. Gelatin and other hydrocolloids for example can gel in the presence of water and can increase in volume in excess of 10 times their original dry volume. The organoleptic qualities of the function-gel compositions in combination with the oranoleptic and nutritional qualities of the meal or snack being supplemented may work in concert. Hence, the combination of various characterizes of functional gels including their volume, weight, energy density, energy content, viscosity, amino acid content, bioavailability, presentation, organoleptic qualities and nutritional value may all contribute, individually and/or in combination, to the improved feelings of satiation, satiety, reduced hunger, reduced energy intake and to the weight loss experienced by the user when consumed as a supplement to the diet, in sufficient quantities and in association with a meal or snack.

Restrained eating requires the exercise of willpower to override likes and wants, especially when there is a lack of or insufficient satiation and satiety provided by a food or meal. The increase in satiation and satiety provided by the compositions and methods of this invention may help to improve compliance with an energy-reduced meal and or energy reduced diet, by promoting a reduction in perceived hunger and a reduction in caloric intake. It is important to note that for example in the case of gelatin which has gelling properties and is also a dietary protein source, its energy density when in hydrated form is much lower than that of any other non gelling proteins. For example, 6 grams of dehydrated gelatin will have a similar energy density to 6 grams of other dehydrated protein i.e. about 4 kcal per gram. However, gelatin will hydrate, gel and set at low temperatures in an aqueous environment to about ten times it original weight, whereas other protein types will not. At ten times its original weight hydrated gelatin has a caloric density of 0.1 kcal per gram. The gelling effect of gelatin will therefore add volume and bulk to functional-gel composition while reducing its energy density, in contrast soy, casein, and whey proteins etc will remain relatively unchanged when hydrated. These properties can be duplicated by non gelatin based functional-gel formulations of the present invention by combining a gelling agent other than gelatin with a protein and especially a hydrolyzed protein or amino acid complex. When ingested, functional-gels including gelatin may take up a higher portion of the gastric volume compared to other proteins and/or increase gastric content viscosity, thereby leading to an increased perception of fullness by a user.

When a food or a snack is consumed in association with functional-gel, including for example gelatin the food or snack portion size can be reduced, providing the user with a lower caloric intake and with a similar or superior gastric fill effect compared to that provided by the full portion of the same food or snack. When food or a snack incorporating a functional-gel, as for example gelatin is consumed, the total caloric value of that food or snack can be reduced while providing the user with a similar or superior gastric fill effect compared to that provided by a non-reduced calorie version of the same food or snack. When consumed in a fully or partially dehydrated form a functional-gel as for example gelatin, it may hydrate in the aqueous contents of the subject's gastrointestinal tract, taking on a viscous consistency especially when accompanied with a cold beverage, adding volume and providing a gastric fill effect that can improve the satiating and satiety effect of a food or meal consumed in association with the functional-gel. Additionally, when a functional-gel or composition comprising a functional-gel as for example gelatin is consumed in association with other food(s), the combination of a functional-gel and other food may have complimentary effects on satiation, satiety, fullness and hunger, as well as a complimentary organoleptic, physiological and psychological effects.

The consumption of a functional-gel or compositions comprising functional-gel as for example gelatin, as a supplement to a food, a meal, a snack or a diet has the added advantage of allowing the user the flexibility to consume a variety of foods as chosen by the subject or as prescribed by the subject's choice of diet. The ability of a subject to continue to consume foods which he or she is accustomed to or has a preference for, while promoting a reduction in energy intake may allow for greater compliance to a reduced calorie diet.

To achieve best utility, the caloric value of functional-gel or composition comprising functional-gel per the present invention, will be less than the caloric value attributable to the portion of the food, meal or snack that was reduced or was excluded, or is intended to be reduced or excluded as a result of consuming the functional-gel or composition comprising functional-gel. For example a meal that is subsequently reduced from 700 kcal to 400 kcal as a result of a subject consuming a 50 kcal functional-gel composition, results in a 300 kcal reduction in food intake for that meal. When accounting for the 50 kcal consumed from the functional-gel composition the net caloric reduction is 250 kcal, a 35.7% reduction in caloric intake for that meal. The Percent Energy Compensation in such a case would be equal to 600%, a significant overcompensation; ([(700-400)/50]×100=600%) In other words the subject will have reduced the caloric consumption of the meal by 6× the caloric contribution of the functional-gel composition.

### Caloric Density

The functional-gel dose or compositions comprising functional-gel will typically have a caloric value that is less than the caloric value of the food or meal to be substituted by the functional-gel or composition comprising a functional-gel. The functional-gel dose will depend upon the amount of functional-gel and or composition comprising a functional-gel that will generate the desired amount of satiation and/or satiety required by the subject. Where the composition comprising a functional-gel is an edible product such as a food or a dietary product, for example a nutritional bar or snack or confection, etc, the edible product is typically administered in an amount ranging from 10 to 500 grams per serving. In one embodiment, the energy density of the composition when in a hydrated form, will typically be less than 4 kcal (kilo calories) per gram of product and will more typically will be less than 3 kcal/g and even more typically will be less than 2 kcal/g and most typically will be less than 1 kcal/g.

The composition of the invention is preferably a low calorie or reduced calorie formulation and may also be a low, reduced or no sugar formulation. The low caloric density of the composition is relative to its intended use and to the need of the subject. For example a subject who wishes to reduce the consumption of a high caloric density food or meal as for example one that has a 9 kcal/gram caloric density would benefit from a composition of the invention which is lower than 9 kcal/gram. Whereas a subject who wishes to reduce his/her intake of a food or meal that has a 3 kcal/gram energy density would require a composition of the invention which is lower than 3 kcal/gram in energy density. Whereas a subject who wishes to reduce his/her intake of a food or meal that has a 2 kcal/gram energy density would require a composition of the invention which is lower than 2 kcal/gram in energy density. Therefore it will be apparent that compositions of various energy densities may be prepared according to need and intended use.

The functional-gel comprises a gelling agent and at least a dietary protein or a least a dietary fiber. Alternatively, the functional-gel comprises a gelling agent and a combination of protein and a dietary fiber. The functional-gel compositions of the invention preferably comprise, on w/w basis of the total weight of the product:
a. About 0.1 percent to 12 percent or more by weight of a gelling agent and
   i. about 4 percent to 98 percent by weight of protein or
   ii. about 4 percent to 98 percent by weight of dietary fiber, or
   iii. a combination of about 0 to 98 percent by weight of protein and between 0 and 98 percent by weight of fiber.
b. and optionally about 2 percent to 90 percent or more of water.

### Viscosity

Where the functional-gels of the present invention have a viscous presentation, the functional-gels will typically have a viscosity of between about 51 and greater than 1,750 mPa·s, and preferably in the Mildly-thick range of about 150 mPa·S and ranging from about 51-350 mPa·s and more preferably in the Extremely-thick range of about 900 mPa·s and ranging from about 1,750 mPa·s or greater, and most preferably in the Moderately-thick range at about 400 mPa·s ranging from about 351-1,750 mPa·s., as further described in the Food Texture and Viscosity: Concept and Measurement, 2nd edition by Malcolm Bourne, Elsevier Science, Academic Press.

### Gelling

Where the functional-gels of the invention are in a gelled presentation, examples of gelling agents that may be employed and their typically characteristics and uses are as follows:

### Agar

Agar creates brittle gels and it must be brought to a boil to hydrate. It sets at room temperature and can be heated to 80° C. (176° F.) before melting. You can also add locust bean gum to agar gels to make them more elastic. Agar is typically used in a ratio of 0.2% to 3.0%. For soft gels a 0.2% to 0.5% range is ideal and the gel becomes harder as more agar is added. Locust bean gum can be added to make the gel more elastic, usually by replacing 10% of the agar with locust bean gum.

Additional information can be found at http://www.modernistcookingmadeeasy.com/info/modernist-ingredients/more/agar-agar, 2015

### Carrageenan

### Iota

Iota carrageenan creates elastic gels and is especially effective with dairy products. It is often used in custards or puddings. It must be heated to hydrate then cooled to set the gel. Once gelled it can be reheated several degrees above the gelling temperature before melting. Iota Carrageenan is normally mixed in a ratio range of 0.02-0.04% to just thicken a dairy based product or a 0.4-1.5% ratio to prepare a dairy gel. Non-dairy gels often require a little more iota in the range of 0.75-1.5%. Since foams are more delicate, a 0.2-1.0% ratio of iota carrageenan is needed to make foams from fluid gels. For dairy fluid gels when blended it takes a ratio range of 0.1-1.0% iota carrageenan. For an end result with a specific elasticity, mix the iota carrageenan and kappa carrageenan together; the total amount of the carrageenans used for gels is a 0.3-1.5% ratio. For a medium elasticity use 1 part iota to 1 part kappa ratio; for an elastic gel a 2 iota to 1 kappa ratio; and for a brittle gel a 1 iota to 2 kappa. Additional information can be found at http://www.modernistcookingmadeeasy.com/info/modernist-ingredients/more/iota-carrageenan-1

### Carrageenan

### Kappa

Kappa carrageenan can be used to create firm, brittle gels and is especially effective at gelling dairy-based liquids. To gel, the liquid must contain either calcium or potassium that is free to bind with the kappa carrageenan. For dairy gels kappa carrageenan is normally mixed in a ratio of 0.3-1.5% range. For dairy fluid gels when blended it often takes a little less, a ratio range of 0.3-1.0% is appropriate. For an end result with a specific elasticity, mix the iota carrageenan and kappa carrageenan together; the total amount of carrageenan used for gels is a 0.3-1.5% ratio. For a medium elasticity use 1 part iota to 1 part kappa ratio; for an elastic gel a 2 iota to 1 kappa ratio; and for a brittle gel a 1 iota to 2 kappa It must be heated to hydrate then cooled to set the gel. Once gelled it can be reheated several degrees above the gelling temperature before melting. Additional information can be found at http://www.modernistcookingmadeeasy.com/info/modernist-ingredients/more/kappa-carrageenan, 2015

### Gelatin

Gelatin forms elastic gels that can't be raised much above room temperature. Gelatin has to be dispersed in hot liquid and sets at room temperature or below. The powdered gelatin referred to in this section has a bloom strength of 225. For this gelatin the ratios often range from 0.5% to 1.0% for soft, tender gels. For very hard, firm gels it can be used in ratios of upwards of 6% but the typical range for medium firm gels is 1% to 3%. For light foams you commonly see a 0.4% to 1.0% ratio powdered gelatin, where a denser foam typically needs a 1.0% to 1.7% ratio. When making marshmallows a ratio of 10% of the liquid is called for. If you are using sheet gelatin you will use 0.3-0.5 sheets per 100 grams of liquid for soft gels and 0.5 to 1.66 sheets per 100 grams of liquid for firmer gels. For very firm gels more than 3.3 sheets per 100 grams of liquid is sometimes used. For a light foam use 0.2 to 0.5 sheets per 100 grams of liquid, a dense foams requires 0.5 to 0.9 sheets per 100 grams of liquid. When making marshmallows a ratio of 5.5 sheets per 100 grams of liquid is common Additional information can be found at http://www.modernistcookingmadeeasy.com/info/modernist-ingredients/more/gelatin, 2015

### Methylcellulose

Methylcellulose has the uncommon ability to gel as it heats, and melt as it cools. There are many different types of methylcellulose available for a variety of uses. For making foams, a ratio mixture of 1.0-2.0% Methocel F50 with 0.1-0.3% xanthan gum is commonly used. For gels a ratio range of 0.25-3.0% Methocel A4C is a good starting point. For more information check out my Guide to Methocel F50 and my Guide to Methocel A4C. Additional information can be found at http://www.modernistcookingmadecasy.com/info/modernist-ingredients/more/methocel-a4c

### Sodium Alginate

Sodium alginate is commonly used in spherification because of its ability to gel in the presence of calcium ions. It can be dispersed and hydrated at almost any temperature and the gels are very heat tolerant. For direct spherification a 0.5% to 1% sodium alginate base is used with a 0.5% to 1% calcium lactate setting bath. For reverse spherification a 1.0 to 3.0% calcium lactate base is used with a 0.4% to 0.5% sodium alginate bath. Additional information can be found at http://www.modernistcookingmadeeasy.com/info/modernist-ingredients/more/sodium-alginate, 2015 and at http://www.modernistcookingmadeeasy.com/info/modernist-ingredients/more/calcium-lactate, 2015.

### Other Gelling Agents

There are many other gelling agents we do not cover in depth but can be found in the Other Ingredients section such as lambda carrageenan, gellan, and pectin. Additional information pertaining to common food gels and gelling properties and food preparations can be found at the Modernist Cooking Made Easy web site by Jason Logsdon, 2015. http://www.modernistcookingmadeeasy.com/info/modernist-techniques/more/gelification-technique#properties_of_gels, September 2015 and in Food Gels (Elsevier Applied Food Science Series), Peter Harris, 1990 and in Gelling Process and New Applications Soumya Banerjee a & Suvendu Bhattacharya a Food Engineering Department, Central Food Technological Research Institute, (Council of Scientific and Industrial Research), Mysore 570020, India

### Dose Ranges

The single dose and total daily dose of the invention will vary widely according to each subject's need, where need is based on but not limited to the subject's species, age, weight, BMI, diet, perceptions of hunger, appetite, fullness and or physical conditions among others.

In one embodiment of the invention, a single dose range in grams per kilogram, where the functional-gel comprises gelatin, typically a subject will benefit from consuming from about 0.014-0.71 gram of gelatin per kilogram of body weight per dose or more on a dry weight basis and preferably 0.057-0.57 g/kg and more preferably from about 0.14-0.5 g/kg. In another embodiment of the invention a single dose range in grams per kilogram, where the functional-gel comprises a protein including for example a hydrolyzed protein or amino acid complex or a gelled protein, typically a subject will benefit from consuming from about 0.014-0.71 gram of protein per kilogram of body weight per dose or more on a dry weight basis and preferably 0.057-0.57 g/kg and more preferably from about 0.14-0.5 g/kg. In yet another embodiment of the invention a single dose range in grams per kilogram, where the functional-gel comprises a dietary fiber or functional fiber, typically a subject will benefit from consuming from about 0.014-0.71 gram of fiber per kilogram of body weight per dose or more on a dry weight basis and preferably 0.057-0.57 g/kg and more preferably from about 0.14-0.5 g/kg.

In one embodiment of the invention, where the functional-gel comprises gelatin, an average human subject of about 70 kg body weight will benefit from about 0.98-49.7 grams of gelatin per dose. In yet another embodiment of the invention, where the functional-gel comprises a protein, including for example a hydrolyzed protein, or amino acid complex an average human subject of about 70 kg body weight will benefit from about 0.98-49.7 grams of protein per dose. In yet another embodiment of the invention, where the functional-gel comprises a dietary fiber and/or functional fiber, an average human subject of about 70 kg body weight will benefit from about 0.98-49.7 grams of fiber in per dose.

In another embodiment of the invention, where the functional-gel comprises gelatin, typically a subject will benefit from consuming from about 4-40 grams most preferable from about 10-35 grams. In yet another embodiment of the invention, where the functional-gel comprises a protein, including for example a hydrolyzed protein, or amino acid complex, or a gelled protein, typically a subject will benefit from consuming from about 4-40 grams most preferable from about 10-35 grams. In yet another embodiment of the invention, where the functional-gel comprises a dietary fiber or functional fiber, typically a subject will benefit from consuming from about 4-40 grams most preferable from about 10-35 grams.

In another embodiment of the invention, typically a subject will benefit from consuming 5-200 grams per day or more on a dry weight basis of functional-gel and preferable 10-150 grams per day, and most preferably 20-100 grams per day.

In another embodiment of the invention, typically a subject will benefit from consuming an amount of functional-gel dose administered on a meal basis is in the range of from about 1.0% to about 95.0% or more of the total meal by weight, and often in the range of from about 2.0 to about 60% or more, often between 5.0 and 50% and most often between 10 and 25%.

In yet another embodiment of the invention, an average human consuming a 350 g meal may require a dose in the range of from about 3.5 to 332.5 grams and often in the range of about 7.0 to 140 grams and more often in the range of 10.5 to 70.0 grams of functional-gel.

Alternatively, the amount of functional-gel dose administered on a daily basis is generally in the range of from about 1% to about 50.0% or more of the total daily diet by weight, and often in the range of from about 2.0 to about 40.0% and more often in the range of 3 to 15%.

Where the composition comprising functional-gel is a food or a dietary product, for example a nutritional bar or snack or confection, etc. the nutritional food composition is typically administered in an amount ranging from 10 to 500 grams per serving. The food comprising functional-gel for example may contain from 1.0% to 100% w/w functional-gel by weight of the composition (when measured on a dry weight basis, i.e. not dissolved in a liquid), typically 5% to 100% w/w and most typically 10% to 95% w/w. Where functional-gel is typically used in edible products as an ingredient or food additive by the industry as for example yogurt, spreads, creams, dressings, ice cream, confections, beverages and the like, etc the content of functional-gel will be at 10% higher than the standard industry use and preferably 20% higher and more preferably 50% higher and most preferably greater than 50% higher or alternatively a sufficient amount higher to improve the satiety of the product.

The dose of functional-gel or composition comprising a functional-gel administered to the subject will, of course, vary depending among other things, on the need of the subject, size of the subject, the particular subject to be treated, and the general health of the subject. Any effective amount may be employed. The dosage can be determined with regard to any established practice to provide an effective dose. The amount of dosage of functional-gel and or composition comprising a functional-gel may be determined based on the subject's: body weight, body mass, body mass index, basal metabolic rate or basal energy expenditure, resting metabolic rate or resting energy expenditure, daily calorie needs, daily energy expenditure, minimum energy requirement, energy consumption, volume of food consumed, weight of food consumed, mass of food consumed, hunger, fullness, appetite, satiety, and or any other appropriate and effective method or combination thereof. Alternatively the amount of dosage may be determined based on averages for a population or sub-population using any of the preceding. Most typically the dose is calculated as a percent of the aforementioned parameters. Validation of several established equations for resting metabolic rate in obese and non-obese people, Journal of the American Dietetic Association, September 2003, David C. Frankenfield, et al.

The present invention is intended to be used to dose all forms of animals including mammals such as humans, non human primates, canines, felines, and swine, among others. The subjects may be of any age, including juvenile, adolescent and adult, with the dosage or amount of the composition of the invention administered, adjusted appropriately. Subjects that may be treated by the methods and compositions described herein are typically human subjects or companion animals. The subjects may be normal subjects (that is, individuals not afflicted with any disease or condition for example subjects in need of an aesthetic effect) or may be subjects afflicted with or at risk for overweight, obesity, metabolic syndrome, or diabetes; or afflicted with or at risk for related diseases or conditions and/or any combination thereof. The present invention is intended to have its primary effect by increasing satiation and or satiety and reducing hunger, and/or reducing caloric intake in association with a meal or snack. Thus it is contemplated as useful in conjunction with the consumption of food, beverages, or meals. The present invention may be used in conjunction with any weight management diet including calorie or macronutrient restricted diets, low fat, low carbohydrate, reduced calorie diets, vegetarian vegan etc. As a benefit of the invention such diets are made more acceptable by reducing hunger and increasing satiety.

Functional-gel or a functional-gel comprising compositions can be taken prior to a meal, during a meal, post a meal, between meals or in any combination thereof. One, two, three or even four or more servings or doses may be administered per day, again depending upon the conditions of the subject and the purpose of the treatment. For example, where used to promote or induce satiety, the food composition may be administered as a meal replacement or as a pre-meal (pre-dose, preload), post a meal or as a between-meal supplement or as a snack. The functional-gel or compositions comprising a functional-gel of the present invention can be used by the subject in need thereof on an acute basis (one occasion), or may be used sub-chronically, (several days, weeks) or chronically (months or years). The functional-gel or composition comprising a functional-gel may be used once per day or several times per day, including as a component of each meal of the day, or as a companion to each meal of the day, or as a snack or companion to a snack between meals. The present invention involves oral administration and the dose of that oral administration may be given prior to a meal, during a meal, after a meal or any combination thereof and preferably 1 hour or less prior to a meal, or during a meal, or up to 2 hours after a meal, or more preferably half an hour or less before a meal, or during a meal, or up to 1 hour after a meal, and most preferably half an hour or less prior to a meal, or during a meal, or up to half an hour or less after a meal, or any combination thereof.

In a preferred embodiment, the one or more functional-gel or compositions comprising a functional-gel are administered in combination with water. Water may be consumed prior to a meal, during a meal, after a meal or any combination thereof and preferably 0.5 hours or less prior to a meal, or during a meal, or the period after a meal up to 0.5 hours post a meal, or any combination thereof. Between four to thirty two ounces (4-32 oz) of water per meal is the preferred volume.

The functional-gel composition can be orally administered to the living animal body by any suitable means and in any suitable form. Where appropriate the functional-gel compositions may be administered by gastric tube or similar method.

### Active Ingredients

### Gelling Agents

Among the active materials suitable for use in the practice of the present invention are gelling agents including thickeners, gums and hydrocolloids many of which are described in “Food Stabilizers, Thickeners and Gelling Agents, Alan Imeson, Aug. 24, 2014 John Wiley & Sons”. The gelling agent of the functional-gel composition may comprise a single gelling agent or a combination of several or more gelling agents. Gelling agents include edible thickeners, gums and hydrocolloids from any source including plant, animal and synthetic origin, including gelatin. Gelatin sources may be any available and suitable for the practice of the invention including porcine, bovine and piscine.

Natural gums are polysaccharides of natural origin, capable of causing a large increase in a solution's viscosity, even at small concentrations. In the food industry they are used as thickening agents, gelling agents, emulsifying agents, and stabilizers. Most often these gums are found in the woody elements of plants or in seed coatings. Natural gums obtained from marine sources include but are not limited to: Polyelectrolytes: Agar (E406); alginic acid (E400) and sodium alginate (E401); carrageenan (E407); kappa-carrageenan, nu-carageenan, iota-carageenan. Natural gums obtained from non-marine botanical resources including but are not limited to: Polyelectrolytes: gum arabic (E414, gum ghatti, Gum tragacanth (E413), karaya gum (E416), and Uncharged: guar gum (E412), locust bean gum (E410), Beta-glucan, Chicle gum, dammar gum, glucomannan (E425), mastic gum, psyllium seed husks, spruce gum, tara gum (E417). Natural gums produced by bacterial fermentation: Polyelectrolytes: gellan gum (E418) Uncharged: xanthan gum (E415). Gums and hydrocolloids also include but are not limited to carboxymethylcellulose, cellulose, gelatin (E441), curdlan, arabinoxylan, pectin, and starch. Hydrocolloids, often called gums are hydrophilic polymers, of vegetable, animal, microbial or synthetic origin, that generally contain many hydroxyl groups and may be polyelectrolytes. They are naturally present or added to control the functional properties of aqueous foodstuffs. Most important amongst these properties are viscosity (including thickening and gelling) and water binding but also significant are many others including emulsion stabilization, prevention of ice re-crystallization and organoleptic properties. Gelatin for example, is a suitable an animal hydrocolloid that swells and absorbs room-temperature water, up to five to 10 times its weight. It dissolves in hot water, and forms a gel upon cooling. It is commonly used as a gelling agent in food. In the term gelatin we include any proteinaceous material derived by hydrolytic extraction of collagen obtained from the bones, skins, and connective tissues of animals. The gelling agents that may be utilized in the compositions of the invention include any gelling agent or blend suitable for human consumption. Gelling agents are well known by those skilled in the art and can be readily selected when preparing such products. Commercial gelling agent sources are readily available and known to one practicing in the art.

### Proteins

Among the active materials suitable for use in the practice of the present invention are dietary proteins many of which are described in the “Dietary Reference Intakes for Energy, Carbohydrate, Fiber, Fat, Fatty Acids, Cholesterol, Protein, and Amino Acids (Macronutrients) (2005)/10 Protein and Amino Acids, National Academy Press and Scientific” and in the “Opinion on Dietary Reference Values for protein, EFSA Panel on Dietetic Products, Nutrition and Allergies (NDA), European Food Safety Authority (EFSA), Parma, Italy, EFSA Journal 2012; 10(2):2557”. The protein source of the functional-gel composition may be from plant animal or fungal sources and may contain intact proteins, hydrolyzed proteins, amino acids, or some combination thereof. The protein source may consist of a single protein type or may consist of a combination of several or even many protein sources. The proteins that may be utilized in the compositions of the invention include any protein or blend suitable for human consumption. Examples of suitable proteins include but are not limited to cassein, collagen, albumin, whey, milk protein, egg, meat, mycoprotein, soy, pea, rice, corn, hydrolyzed protein and mixtures thereof. The protein source may be lactose-free so it can be used for lactose intolerant subjects. Proteins are well known by those skilled in the art and can be readily selected when preparing such products. Commercial protein sources are readily available and known to one practicing in the art.

### Gelatin as Protein

A preferred protein source is gelatin prepared from collagen. Gelatin sources may be any including porcine, bovine and piscine from skin, bone or any other suitable source. In the term gelatin we include any proteinaceous material derived by hydrolytic extraction of collagen obtained from the bones, skins, and connective tissues of animals. The gelatin source for the present invention may be any source or blend available for human consumption. Gelatins are well known by those skilled in the art and can be readily selected when preparing such products. Commercial gelatin sources are readily available and known to one practicing in the art.

### Dietary Fiber

Among the active materials suitable for use in the practice of the present invention is fiber including dietary and functional fiber. A description of dietary and function fibers can be found in Dietary Reference Intakes for Energy, Carbohydrate, Fiber, Fat, Fatty Acids, Cholesterol, Protein, and Amino Acids (Macronutrients) (2005)/7 Dietary, Functional, and Total Fiber, National Academy Press. Sources of fiber include but are not limited to plant, animal, microbial or of synthetic origin. Fiber sources include but are not limited to soluble and insoluble dietary fiber and preferably a combination of the soluble and insoluble type and including the mucilage kind. Included in the definition of dietary fiber are resistant starches and modified starches, isolated or manufactured, such as those classified as RS1, RS2, RS3 and RS3, and non-absorbent carbohydrates resistant to endogenous digestion in the human upper digestive tract and indigestible or resistant oligosaccharides. Also included in the definition of dietary fiber are non-absorbant carbohydrates, and indigestible oligosaccharides. Food sources of soluble fiber including but are not limited to fruits, vegetables, legumes, seeds, nuts, tubers, oats, rye, chia, barley, root tubers, root vegetables, psyllium seed husk, chitin and chitosan, raw starch and raw cornstarch. Other examples of dietary fiber include cellulosics, like CMC, HMC, HPMC, pullulan, cellulose, Beta-glucans, hemicelluloses, inulin, oligofructose and fructooligosaccharides, lignin, pectins, polydextrose, resistant dextrins, alginates, plant waxes, natural gums, raffinose, xylose, lactulose, carboxymethyl cellulose.

### Examples of Soluble Fiber

Representative of soluble dietary fiber sources are gum Arabic, sodium carboxymethyl cellulose, guar gum, citrus pectin, polydextrose, low and high methoxy pectin, oat and barley glucans, carrageenan and pysyllium. Numberous commercial sources of soluable dietary fiber are readily available and known to one practicing in the art. For example, gum Arabic, carboymethyl cellulose, guar gum, pectin and the low and high methoxy pectins are available from TIC Gums, Inc. of Belcamp, Md. The oat and barley glucans are available from Moutnain Lak Specialty ingredients Inc. of Omaha Neb. Psyllium is available from the Meer Corporation of North Bergen N.J.>while the carnageenan is available from FMC Corporation of Philadelphia, Pa. Sources of insoluble fiber including but not limited to: whole grain foods, wheat and corn bran, nuts and seeds, potato skins, flax and hemp seed, lignans, vegetables celery, nopal, soy, and fruits

### Examples of Insoluble Fiber

Representative of the insoluble dietary fibers are oat hull fiber, pea hull fiber, soy hull fiber, soy cotyledon fiber, sugar beet fiber, cellulose and corn bran. Numerous sources for the insoluble dietary fibers are als readily available and known to one practicing in the art. For example the corn bran is available from Quaker Oats of Chicago Ill.; oat hull fiber from Candaian Harvest of Cambridge, Minn.; pea hull fiber from Woodstone Foods of Winnipeg, Canada; soy hull fiber and oat hull fiber from Protein Technologies International of St. Louis, Mo.; sugar beet fiber from Delta Fiber foods of Minneapolis, Min. and cellulose from the James river corp of Saddle Brook, N.J.

Sources of muscilage fiber include but are not limited to aloe vera, malabar spinach, cactus, chondrus crispus, dioscorea opposita, drosera, fenugreek, flax seeds, kelp, liquorices root, mullein, okra, parthenium, pinguicula, psyllium seed husks, salvia hispanica seed, and ulmus rubra bark. The dietary fiber and/or functional fiber source for the present invention may be any source or blend of sources available for human consumption. Dietary fiber and function fiber are well known by those skilled in the art and can be readily selected when preparing such products. Commercial dietary fiber and functional fiber sources are readily available and known to one practicing in the art.

Dietary fiber, as used herein and in the claims, understood to be all of the components of a food that are not broken down by the endogenous enzymes in the human digesting tract to small molecules that are absorbed into the bloodstream. These food components are mostly celluloses, hemicelluloses, pectin, gums, mucilages, and lignins. Fiber differ significantly in their chemical composition and physical struction and therefor their physical functions.

As used herein and in the claims “soluble” and “insoluble” dietary fiber may be determined using American Association of Cereal Chemists (AACC) Method 32-07. As used herein and in the claims, “total dietary fiber” or “dietary fiber” is understood to be the sum of the soluble and insoluble fiber determined by AACC method 32-07 and wherein by weight and least of the fiber source comprises dietary fiber. As used herein and in the claims a “soluble” dietary fiber source is a fiber source in which at least 60% of the dietary fiber is soluble dietary fiber as determined by AACC Method 32-07, and an “insoluble” dietary fiber source is a fiber source in which at least 60% of the total dietary fiber is insoluble dietary fiber as determined by AAACC Method 32-07. Dietary Reference Intakes: The Essential Guide to Nutrient Requirements; The essential guide to nutrient requirements, 2006 Institute of Medicine, of the National Academies. National Academy Press, Washington D.C. A more detailed discussion of fibers and their incorporation into formula may be found in U.S. Pat. No. 5,085,883 issued to Garleb et al, which is hereby incorporated by reference.

### Resistant and Modified Starches

Among the materials suitable for use in the practice of the present invention are modified starches Included in the definition of dietary fiber for the purposes of this invention are resistant starches, isolated or manufactured, such as those classified as RS1, RS2, RS3 and RS3. According to our invention, the useful modified starches may be the starch products derived by chemical means from any plant source including corn, waxy maize, potato, sweet potato, wheat, rice, sago, tapioca, sorghum, high amylose corn, and the like. Also included among the modified starches suitable for use in the practice of this invention are the thermally converted, fluidity or thin boiling type products derived from the aforementioned type chemically modified starches. Such materials may be of the lower molecular weight type prepared by heating the modified starch alone or by subjecting the said starch to a combined hydrolytic acid and heat treatment or by any other known method designed for the thermal conversion of the starch such as enzymic heat treatment. The particular type starch chosen will depend on its usefulness, availability, and cost. Among the useful modified starches are the succinates, alkenyl succinates, diethylaminoethyl ethers, phthalates, sulfonates, carboxymethylated and chlorinated derivatives of native starches or thermally converted native starches. Preferred modified starches include the alkenyl succinates, and succinates of waxy maize starch. The preparation of the modified starches may be carried out by any conventional method whereby the hydroxyl groups of the anhydroglucose unit of the starch base are partially modified by the substituent groups. Typical methods for the preparation of starch derivatives useful herein are discussed by H. J. Roberts in StarchzChemistry and Technology, Vols. 1 and 11, Academic Press, New York, 1965 and 1967, respectively; various other methods: would include those taught in assignees U.S. Pat. Nos. 2,461,139, 2,661,349, 2,802,000, 2,813,093, and 2,825,727.

With regard to proportions, and as a non limiting example, the concentration of the starch may range from about 3 to 60 percent, preferably to 40, based on the total weight of the solids. For example it is preferred that a thermally converted n-octenyl succinate of waxy maize or a thin boiling succinate of waxy maize be used as an extender in amounts ranging from 15 to 40 percent, by weight of the composition.

### Non Absorbent Carbohydrates

The term “nonabsorbent carbohydrates” refers to a carbohydrate moiety with a degree of polymerization great than about 20 and/or a molecular weight greater than about 3,600, that is resistant to endogenous digestion in the human upper digestive tract. Nonabsorbent carbohydrates possess many of the characteristics of total dietary fiber. However, they are not quantifiable by AACC Method 32-07 for fiber and consequently they are not included in total dietary fiber values of the instant invention. However for purposes of the invention we include Non-absorbent Carbohydrates within our dietary fiber definition. Examples of nonabsorbent carbohydrate sources of the instant invention typically include chemically modified starches such as Fibersol, polydextroxe and inulin, (Lazarus Resistant Starch Carbs Help Weight Loss Jan. 29, 2011 PAK. J. FOOD SCI., 22(2), 2012:9.)

### Indigestible Oligosaccharides

Among the materials suitable for use in the practice of the present invention are indigestible oligosaccharides. Oligosaccharides that are resistant to digestion are another form of dietary fiber. The human digestive tract lacks the enzymes necessary to break down fibers, allowing them to pass through the digestive tract. Indigestible oligosaccharides are rapidly and extensively fermented to short chain fatty acids by anaerobic micro-organisms that inhabit the larger bowel. These oligosaccharides are preferential energy sources for most Bifidobacterium species, but are not utilized by potentially pathogenic organisms such Clostridum perfingens, C. difficile, or E. coli. While the name is still largely unfamiliar to consumers, these compounds are being added to many food and supplement products and include inulin, oligofructose, FOS (fructo-oligosaccharides) and GOS (galacto-oligosaccharides). They are natural constituents of many plants and vegetables including chicory root, Jerusalem artichoke, onions, legumes, wheat, barley and asparagus, The indigestible oligosaccharide source for the present invention may be any source or blend of sources available for human consumption. Indigestible oligosaccharides are well known by those skilled in the art and can be readily selected when preparing such products. Commercial indigestible oligosaccharides sources are readily available and known to one practicing in the art. The term “indigestible oligosaccharide” includes a small carbohydrate moiety with a degree of polymerization less than or equal to about 20 and/or a molecular weight less than or equal to about, 3,600, that is resistant to endogenous digestion in the human upper digestive tract.

### Gelatin

Among the materials suitable for use in the practice of the present invention are gelatins. Gelatins may be employed as active components of the functional-gel composition such as the gelling agent or the protein source or may be employed as nutritive or function additive or ingredient. Hydrolyzed collagen (gelatin) is a translucent, colorless, brittle (when dry), flavorless solid substance, derived from collagen obtained from various animal by-products. It is commonly used as a gelling agent in food. In the term gelatin we include any proteinaceous material derived by hydrolytic extraction of collagen obtained from the bones, skins, and connective tissues of animals. Such materials may be obtained by hydrolytic extraction in an alkaline (lime) or acidic medium and thereafter treated for use in a particular application. Typically Type A is derived from pork skin by hydrolysis with an acid and Type B is derived from bones and animal skin by hydrolysis with an alkaline solution. Gelatin typically contains a mixture of water-soluble proteins (84-90 percent), mineral salts (1-2 percent), and water (8-15 percent). These proteins contain a significant amount of the amino acids: glycine, proline, hydroxyproline, glutamic acid, alanine, arginine, aspartic acid, lysine; in addition to other amino acids in smaller amounts. Gelatin is odorless, tasteless, colorless, and insoluble in most organic solvents, but soluble in glycerin, diluted acids and alkalis. Gelatin swells and absorbs room-temperature water, up to five to 10 times its weight. It dissolves in hot water, and forms a gel upon cooling. For example, the gelatin may be produced by accurately controlling the depolymerization of the protein collagen and then chemically refined, e.g., by ion exchange to meet the specifications appropriate for the particular application. Gelatin may also be known as Collagen Hydrolysate, Collagène Dénaturé, Collagène Hydrolysé, Collagène Marin Hydrolysé, Denatured Collagen, Gelatina, Gelatine, Gélatine, Gélatine Hydrolysée, Hydrolised Collagen, Hydrolysed Collagen, Hydrolyzed Collagen, Hydrolyzed Collagen Protein, Hydrolyzed Gelatin, Marine Collagen Hydrolysate, Protéine de Collagene Hydrolysé, collagen peptide and gelatine hydrolysate. Mechanical properties of gelatin and gels (for example the gel strength, which is quantified using the Bloom test) are very sensitive to temperature variations, previous thermal history of the gel, and time. The viscosity of the gelatin/water mixture increases with concentration and when kept cool (≈4° C.). Bloom is linked to mechanical elasticity of the gel and is used to classify gelatine types. It generally ranges from 50 to 300 Bloom. We may sometime refer to Low, Medium or High Bloom, with the following limits: Low Bloom: gel strength below 120-g Medium Bloom: gel strength between 120 and 200-g High Bloom: gel strength above 200-g. Gel strength increases with concentration and time as the gel matures. It decreases with temperature. Uses and production methods of gelatin are described in Addalbasit Adam Mriod, Hadia Fadol Adam Review: Gelatin, Source, Extraction and Industrial Applications. Acta Sci. Pol., Technol. Aliment. 12(2) 2013, 135-147, which is incorporated by reference herein. The gelatin source for the present invention may be any source or blend available for human consumption. Gelatins are well known by those skilled in the art and can be readily selected when preparing such products. Commercial gelatin sources are readily available and known to one practicing in the art.

Among the gelatins suitable for use in the practice of the present invention are instantized gelatin. Instantized gelatins are cold soluble, yet have the same or similar textural properties as traditional gelatin. Cold soluble gelatin will start dissolving when it comes into contact with a cold liquid (water, milk, fruit juice, etc.). As there is no heat involved in the preparation, instantized gelatin will immediately impact the viscosity, thickening or air entrapment of the preparations. U.S. patent Ser. No. 07/229,462 titled Instantized gelatin soluble in cold water is incorporated by reference herein.

Acceptable sources of gelatin include but are not limited to mammals, birds, fish, reptiles, amphibians and preferably from bovine, swine, and piscine sources. Any suitable collagen type and source may be used for the production of gelatin, including synthetically produced collagen as for example recombinant gelatin.

### Commercial Sources of Gelatin

Gelatin is available commercially and can be purchased from manufacturers or distributors such as for example: Gelita USA (Iowa USA), Kraft foods, nitta gelatin (Osaka Japan), PB Leiner (Vilvoorde, Belgium), Rousselot International/Rousselot Inc. (Mukwonago, Wis., USA), Weishard International (Graulhet France).

### Combinations

Gelatin may be combined with other gums or gelling agents such as seaweed extracts, agar and carrageenan, as well as pectin and konjak. Gelatin may also be combined with other colloidal products such as psyllium, gums, etc. Gelatin may also be combined with various bulking agents including carbohydrate, protein, and alcohol based agents including but not limited to polydextrose, modified starches and fiber.

### Gelatin Alternatives

There are non-animal based forms of gelatin to meet the needs of those wishing to avoid animal products for example those with vegetarian, ethical or religious dietary restrictions. Among the non-animal alternatives to gelatin are included the seaweed extracts agar and carrageenan, as well as pectin and konjak. When gelatin is substituted with another hydrocolloid it should be fortified with either a protein source or a dietary fiber source or a combination of both. In the case of a protein source, the source may include any animal or plant source. However when the intended product is designed to be vegetarian a protein plant source is the preferred source.

### EXPERIMENTS

### Experiment 1

### Energy Intake and Weight Loss Human Subject Study

To evaluate the effects of a functional-gel composition comprising gelatin on energy intake and body weight, a Male 46 years of age with a BMI of 26.8, participated in an open label study consisting of two test experiments, a control experiment and a baseline pre-test evaluation period. Each of the two experimental test periods was conducted over 8 weeks while the baseline pre-test period was conducted over a 4 week time frame. The subject reported having a stable body weight of 159-161 lbs over a period of time exceeding one year. The subject also reported having undertaken various attempts to lose weight over the past 5 years, including attempts to reduce caloric intake and undertake an exercise program. Additionally, the subject reported not being able to lose more than 2 lbs in any prior weight loss attempt and that maintaining the weight loss was very difficult, due to recurring perceived hunger and cravings.

### Baseline

Average caloric consumption, during a pre-test 4 week observational period was 1,888 kcal per day, without modification to routine diet and without any exercise intervention, except for the consumption of 120 mL of filtered tap water used as the preload prior to each of three main meals of the day, typically less than 30 min prior to the meal.

### Control

For the control experiment, the subject consumed a preload with each of the three main meals of the day. The preload consisted of a hydrocolloid in sugar water. The composition was consumed within 30 min prior to, during or within 15 min post a meal. The control composition consisted of 10 g (0.0 kcal) of whole psyllium husks (Health Plus Inc, Chino Calif., USA) and 11 g (41.25 kcal) pure cane sugar (C&H Crockett, Calif. USA), and 2.5 grams (10 kcal) of sugar free gelatin mix (including 0.4 g gelatin, Jell-O® Kraft Foods Global, Northfield Ind. USA), in 120 mL of filtered tap water. The total caloric content of the composition was approximately 51.25 kcal per dose. Initial body weight was 159 lbs and initial BMI was 26.5. Final body weight was 161.9 lbs, an increase of 2.9 lbs or 1.8% from initial body weight. The ending BMI was 26.9. The subject did not report changes in perceived hunger, satiation, or satiety after consumption of control composition. Average caloric consumption, during the control period was 1,930 per day, without modification to routine diet and without any exercise intervention. The mean energy compensation over the water preload baseline was a −27.3%, calculated as follows: % Compensation=[(1,888−1,930)/(153.75)]=−27.3% (negative compensation).

### Test 1

For the test experiment, the subject consumed a functional-gel composition comprising gelatin with each of three main meals per day; less than 30 min prior, during or within 15 min post the meal. The composition comprising gelatin consisted of 12.6 g (45.1 kcal) of dry gelatin powder (Knox® Kraft Foods Global, Northfield Ind., USA) and 2.5 grams (10 kcal) of sugar free gelatin mix (including 0.4 g gelatin, Jell-O® Kraft Foods Global, Northfield Ind. USA) hydrated in 120 mL of filtered tap water to a firm gelatin texture (at 4-8° C.) similar to that of a gummy confection. The total caloric content of the composition was approximately 55.1 kcal per dose. Initial body weight was 160 lbs and final body weight was 152 lbs, a difference of 8 lbs or 5% of initial body weight and an ending BMI of 25.3. The average caloric consumption over an 8 week period was 1,299 per day, resulting in an average energy compensation of 356%, calculated as follows: % Compensation=[(1,888−1,299)/(55.1×3)]×100=[589/165.3×100]=356% (overcompensation).

### Test 2

For the second test experiment, the subject was allowed to regain body weight to a baseline level over a 6 week period prior to initiation of the study. Upon commencement of the study, the subject was instructed to consume a functional-gel composition comprising gelatin and raw corn starch (fiber, functional fiber) hydrated in 120 mL to a firm gelatin texture similar to that of a gummy candy, the test composition was consumed with each of three major meals each day; prior, during or within 15 min post a meal. The composition comprising gelatin consisted of 6 g (21.48 kcal) of dry gelatin powder (Knox® Kraft Foods Global, Northfield, Ind. USA) 6 grams of raw cornstarch (22.87 kcal) and 2.5 grams of sugar free gelatin mix (including 0.4 g gelatin) (Jell-O® Kraft Foods Global, Northfield Ind., USA) for a total of 54.36 kcal per dose. Initial body weight was 159.8 lbs and final body weight was 153.1 lbs, a difference of 6.7 lbs or 4.1% of initial body weight and an ending BMI of 25.0. The average caloric consumption over an 8 week period was 1,360 per day, resulting in an average energy compensation of 324%. % Compensation=[(1,888−1360)/(54.36×3)]=[528/163.08]×100=324% (overcompensation)

TABLE 1
Results

| | Study | Preload | Mean | | Average | B.W. change | % B.W. |
|---|---|---|---|---|---|---|---|
| Study | Duration | Composition | Kcal Day | T/C | EC | (lbs)*** | Change |
| Baseline | 4 wks | Filtered | 1,888 | n/a | n/a | n/a | n/a |
| | | Water | | | | | |
| Control | 8 wks | Hydrocolloid + | 1,930 | 1.02* | −27.3% | −2.9 | −1.8% |
| | | sugar | | | | | |
| Test 1 | 8 wks | Gelatin | 1,299 | 0.69** | 356% | 8.0 | 5.0% |
| Test 2 | 8 wks | Gelatin + resistant | 1,360 | 0.72** | 324% | 6.7 | 4.1% |
| | | starch | | | | | |

*T = control and C = Baseline,
**T = Test and C = control,
***BW change is body weight change in lbs calculated as (initial body weight − final body weight),

### Experiment 2

### Energy Intake and Weight Loss Rodent Study

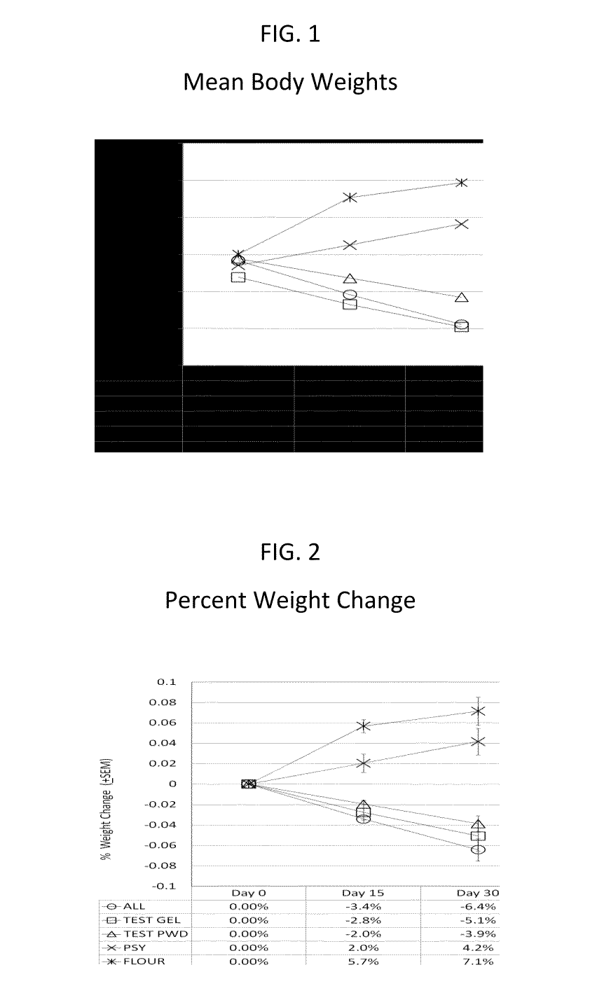

Fifteen adult female feeder mice were preconditioned for 15 days on a 20% fat diet. PicoLab Rodent diet 20 was supplemented to 15% fat by adding a mixture of fats consisting of (38% butter, 30% shortening, 23% lard, and 8% canola oil). High fat diet was provided ad libitum. After the pre-conditioning period mice were assigned to one of four groups (3 female mice per group) to generate similar mean body weights between groups as described below. Mice were given control or test article preloads one hour prior to receiving ad libitum high fat diet on a daily basis, mice received high fat diet at ad libitum over night (rodent active period of the day) and were fasted during day time hours (the rodent dormant period of the day). Body weights were obtained on Day 15 and Day 30 post treatment initiation and data was used to calculate change in body weight from baseline, Day 0. Mean body weights (FIG. 1) and % change in body weight (FIG. 2) data is provided with corresponding SEM. Partially hydrolyzed collagen (GEL group) test article was hydrated in 10× in hot water then allowed to set to firm gel 4-8° C. overnight. Wheat Flour (FLOU group) and Psyllium (PSY group) test articles were hydrated in water. Wheat Flour was cooked via microwave for 2 min at an 800 Watt setting. FIG. 1 titled “Mean Body Weights” and FIG. 2 titled “% Weight Change” summarize the results of the study, which show that the functional-gel compositions of the invention (Study groups GEL and GEL PWD) a gelled gelatin composition and a powdered gelatin composition respectively, resulted in weight loss over a 30 day treatment period, a similar response to that of the positive control group (ALLI) an FDA approved weight loss drug. Whereas the two negative control groups (PSY and FLOUR) consisting of a psyllium husk mucilage type dietary fiber (Now Foods) and FLOUR a commercially available wheat flour both had increases in body weight over the same test period.

TABLE 2
Groups and Dosing

| | Test (T) or | | | | |
|---|---|---|---|---|---|
| Group ID | Control (C) | Description | Composition | Dose (g) | Kcal/dose |
| ALLI | C | Positive control | Alli ®/Orlistat (60 mg) | 2 mg/kg | N/A |
| PSY | C | Hydrocolloid Control | Psyllium husk | 1.5 g | 0.0 |
| FLOUR | C | Caloric Control | Wheat flour | 1.5 g | 5.0 |
| | | | (cooked) | | |
| GEL | T | Hydrated Test | Hydrolyzed collagen | 1.5 g | 5.37 |
| | | | (gelled) | | |
| GEL PWD | T | Dehydrated Test | Hydrolyzed collagen | 1.5 g | 5.37 |
| | | | (powdered) | | |

TABLE 3
Final Body Weight Statistical Significance*

| | | Statistical |
|---|---|---|
| Groups | p value | Significance |
| ALLI vs FLOUR | p = 0.00663 | yes |
| GEL vs ALLI | p = 0.94196 | no |
| GEL vs FLOUR | p = 0.00727 | yes |
| GEL PWD vs FLOUR | p = 0.02183 | yes |
| PSY vs FlOUR | p = 0.33623 | no |
| GEL vs GEL PWD | p = 0.447727 | no |
| GEL PWD vs FLOUR | P = 0.02183 | yes |

*Statistical significance between groups was evaluated by independent samples student's t-test (p < 0.05). yes = statistical significance, no = no statistical significance.

### Experiment 3

### Weight Loss Rodent Study

Forty adult female mice were preconditioned for 15 days on a 20% fat diet. PicoLab Rodent diet 20 was supplemented to 15% fat by adding a mixture of fats consisting of (38% butter, 30% shortening, 23% lard, and 8% canola oil). High fat diet was provided ad libitum. After the pre-conditioning period mice 30 mice were selected and assigned to one of ten (10) groups (Table 4), 3 female mice per group, to generate similar mean body weights between groups as described below. For test period, mice were given control or test article preloads, one hour prior to receiving ad libitum high fat diet on a daily basis, mice received high fat diet at ad libitum over night (rodent active period of the day) and were fasted during day time hours (the rodent dormant period of the day). The compositions consisted of about 1.5 g each of test or control article plus about 0.2 g agar-agar in about 5 mL of water. Body weights were obtained on Day 30 post treatment initiation and data was used to calculate change in body weight from baseline (Day 0). Mean body weights and % change in body weight data is provided (Table 5). A 2.5% aga-agar was prepared in boiling filtered water for about 3 min. About 5 mL of hot liquid agar-ager was then mixed with each of the test articles (Groups A-G) or control articles (Groups H and J) and allowed to set. Except for Group I (Agar-agar control) to which a 12.5% agar-agar was prepared by boiling in filtered water for about 3 min. Test and control articles were sourced as follows: Agar-agrar (Now Foods), Hydrolyzed Collagen, (NeoCell), Apple Fiber (Now Foods), Amino Acids Complete (Now Foods), Whey Protein Concentrate (Now foods), Soy Protein (Now Foods), Soluble fiber (Benefiber), Wheat flour (King Arthur). Table 4 provides a description of the study groups and corresponding doses and calorie density of treatments. Table 5 provides a summary of the results which show that functional-gel compositions (Groups A-G) results in body weight loss whereas the controls resulting in body weight gains (Groups H-J).

TABLE 4
Experimental Groupings

| Group | Test (T) or | | | Caloric |
|---|---|---|---|---|
| ID | Control (C) | Composition | Kcal/dose | Density |
| A | T | Agar + Hydrolized collagen | 6.48 | 0.97 |
| B | T | Agar + Apple Fiber | 4.38 | 0.65 |
| C | T | Agar + Hydrolyzed collagen + Apple Fiber | 5.18 | 0.77 |
| D | T | Agar + Amino Acids | 6.25 | 0.93 |
| E | T | Agar + Amion Acids + Apple Fiber | 5.63 | 0.84 |
| F | T | Agar + Whey Protein | 6.53 | 0.98 |
| G | T | Agar + Soy Protein | 6.25 | 0.93 |
| H | C | Agar + Benefiber | 3.52 | 0.52 |
| I | C | Agar-agar | 5.31 | 0.79 |
| J | C | Wheat flour | 6.09 | 0.91 |

TABLE 5
Body Weights at Baseline Day 0 and Day 30
post treatment and % change.

| ID | DESCRIPTION | Day 0 | Day 30 | % Change |
|---|---|---|---|---|
| A | GEL + PROTEIN | 25.0 | 23.9 | −4.2% |
| B | GEL + FIBER | 26.2 | 25.4 | −3.0% |
| C | GEL + (PROTEIN + FIBER) | 25.7 | 24.1 | −6.0% |
| D | GEL + AA | 25.7 | 24.8 | −3.4% |
| E | GEL + (AA + FIBER) | 24.2 | 23.0 | −4.9% |
| F | GEL + PROTEIN (WHEY) | 25.8 | 25.0 | −3.2% |
| G | GEL + PROTEIN (SOY) | 25.5 | 24.4 | −4.4% |
| H | GEL + SOL. FIBER | 25.6 | 26.5 | 3.5% |
| I | GEL | 25.7 | 27.0 | 5.1% |
| J | FLOUR | 25.3 | 26.8 | 6.1% |

### Experiment 4

### Acute Satiety Effects on Human Subjects

In a cross over study, we investigated the effect of a functional-gel composition comprising gelatin as a preload vs a water control preload on food intake and caloric intake in four male volunteers, 14 to 46 years of age, BMI range: (16.7-28). The volunteers were tested on 3 consecutive days to establish a food intake and energy intake baseline with a water preload as control. The following week the same volunteers were tested on 3 consecutive days using a gelatin preload composumed as the treatment. For the baseline and test experiments, the subjects were offered an ad libitum lunch subsequent to a 120 mL water preload or gelatin composition preload, which were consumed within a one half hour period, just prior to the test meal lunch. The subjects were instructed to eat as much of the test lunch meal as desired until they felt full and satiated. The lunch consisted of large pepperoni pizza (Little Caesar's Pizza, CA, USA). The test gelatin composition used for treatment consisted of 12.6 g (45.1 kcal) of dry gelatin powder (Knox® Kraft Foods Global, Northfield Ind., USA) and 2.5 grams (10 kcal) of sugar free gelatin mix (including 0.4 g gelatin, Jell-O®Kraft Foods Global, Northfield Ind. USA) hydrated in 120 mL of filtered tap water and prepared similar to that of a gummy confection to a firm gelatin texture at 4-8° C. The total caloric content of the composition was about 55.1 kcal per dose, with a caloric density of about 0.41 kcal/g.

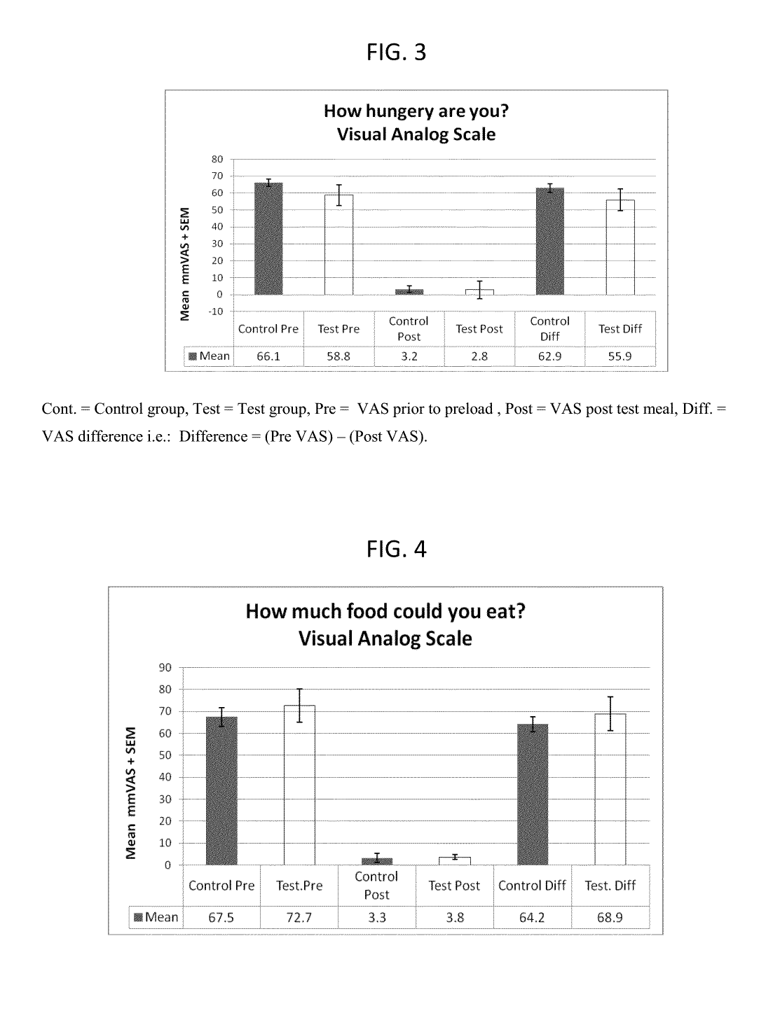

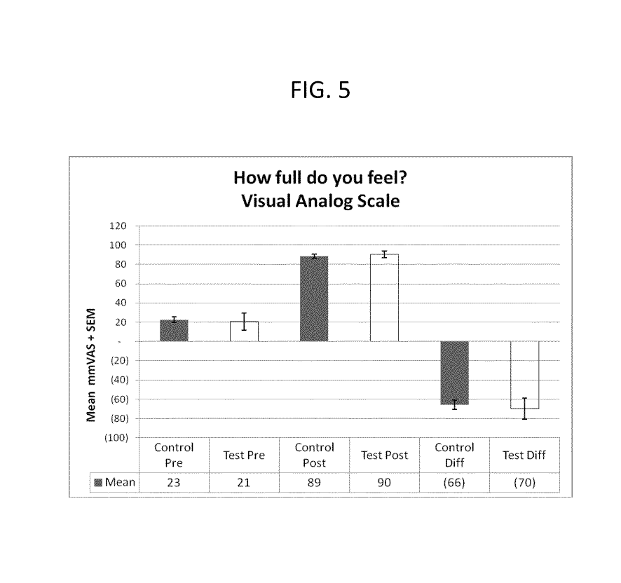

Appetite profiles were taken via 100 mm horizontal Visual Analog Scales for hunger (FIG. 3), desire to eat (FIG. 4) and fullness (FIG. 5) prior to a preload and post consumption of the lunch test meal for both the water (Cont.=control) and gelatin (Test=treatment) groups. Food Intake was measured by weighing the pizza consumed by each subject. Energy intake was calculated based on pizza consumed weights. The caloric composition of the pizza was obtained from the company's web site as 2.19 kcal/gram.

Mean Food Intake and Energy Intake values were lower for the treated group versus the control group, with a mean food intake reduction of 37%, a mean energy intake reduction of 36% and Energy Compensation of 463% (Tables 6 and 7). Mean VAS results for “hunger”, “desire to eat: and “fullness” were similar for control and test groups (FIGS. 3, 4 and 5).

TABLE 6
Food Intake (g)

| | Baseline control | Gelatin Test | Mean Change | % |
|---|---|---|---|---|
| Subject | Mean (g) ± SEM | Mean (g)) ± SEM | (g) | Change |
| 1 | 361 ± 69 | 209 ± 69 | 152 | 42 |
| 2 | 369 ± 17 | 214 ± 17 | 155 | 42 |
| 3 | 559 ± 17 | 443 ± 17 | 116 | 21 |
| 4 | 419 ± 28 | 230 ± 28 | 188 | 45 |
| Group | 433 ± 45.8 | 274 ± 57 | 153 | 37 |

TABLE 7
Energy Intake

| | | Gelatin Test | | | |
|---|---|---|---|---|---|
| | Baseline | (Mean kcal ± | Change | % | |
| Subject | (Mean kcal ± SEM) | SEM) | (Mean) | Change | % EC |
| 1 | 816* ± 156 | 473 ± 12 | 343 | 42 | 464 |
| 2 | 835 ± 38 | 484 ± 93 | 350 | 42 | 512 |
| 3 | 1,263 ± 38 | 1,002 ± 92 | 261 | 21 | 266 |
| 4 | 947 ± 64 | 521 ± 66 | 425 | 45 | 742 |
| Group | 965 ± 104 | 620 ± 128 | 345 | 36 | 463 |

*Subject 1 participated in only two of three baseline sessions.

### EMBODIMENTS

### Methods/Compositions

The beneficial effects that functional-gel has on the user per the invention, can be achieved in a number of ways. In one embodiment of the invention an edible product may be modified to comprise a functional-gel such as gelatin which in so doing reduces the caloric content of the original product without reducing its satiety effect. In another embodiment of the invention an edible product may be prepared that comprises a functional-gel such as gelatin which in so doing reduces the products caloric content while increasing its satiety effect. Alternatively an edible product may be prepared that comprises functional-gel such as gelatin which in so doing maintains its caloric content but increases its satiety effect. When eaten in a sufficient amount, a functional-gel such as gelatin or a low calorie composition comprising functional-gel such as gelatin may be used to increase the satiety of a meal or to increase the satiety of a snack when incorporated into that meal/snack or consumed in association with that meal/snack. When eaten in a sufficient amount, a functional-gel such as for example gelatin or a low calorie composition comprising a functional-gel such as for example gelatin can be used to reduce the caloric intake of a meal or snack when incorporated into that meal/snack or consumed in association with that meal/snack. When eaten in sufficient amount, a functional-gel such as for example gelatin or a low calorie composition comprising a functional-gel such as for example gelatin as in an edible product can be used to increase the satiety of a food or food product when incorporated into that food/food product or consumed in association with that food/food product. When eaten in sufficient amount, a functional-gel such as for example gelatin or a low calorie composition comprising a functional-gel such as for example gelatin as in an edible product can be used to reduce the caloric intake of a food or food product when incorporated into that food/food product or consumed in association with that food/food product. In yet another embodiment of the invention a functional-gel such as for example gelatin may be incorporated into an edible product designed for use in a weight loss program that has been designed to enhance the palatability of the program and thereby enhance patient/consumer acceptance. In another embodiment of the invention a functional-gel such as for example gelatin may also be incorporated into low calorie confections such as but not limited to gelatin desserts, trifles, aspic, marshmallows, candy corn, Peeps, gummy bears, fruit snacks, and jelly babies among others. In another embodiment of the invention a functional-gel such as gelatin may also be incorporated into low calorie snacks such as bars and beverages, among others. In another embodiment of the invention a functional-gel such as for example gelatin or a composition comprising a functional-gel such as for example gelatin may be incorporated into a beverage. In another embodiment of the invention a functional-gel such as a gelatin may be incorporated into meal replacement products, such as beverages, bars and powder mixes, among others.

### Embodiment

### Instruction

In one embodiment, instructions are provided to consume a composition of the invention before eating a reduced calorie meal, or during a reduced calorie meal or after a reduced calorie meal, or any combination thereof to increase the satiation and satiety of the reduced calorie meal.

### Embodiments

### Combinations

In yet another embodiment of the present invention, the functional-gel such as for example gelatin or composition comprising functional-gel such as for example gelatin can incorporate and or be combined with one or more foods such as fruits, nuts, seeds, and vegetables, including pulp and pomace derived from food.

In yet another embodiment of the present invention, the functional-gel such as for example gelatin or composition comprising functional-gel such as for example gelatin can incorporate and or be combined with one or more vitamins. In yet another embodiment of the present invention, the functional-gel such as for example gelatin or composition comprising gelatin can incorporate and or be combined with one or more minerals and or micronutrients. In yet another embodiment of the present invention, the functional-gel such as for example gelatin or composition comprising functional-gel such as for example gelatin can incorporate and or be combined with one or more amino acids. In yet another embodiment of the present invention, the functional-gel such as for example gelatin or composition comprising gelatin can incorporate and or be combined with one or more protein hydrolysates. In yet another embodiment of the present invention, the functional-gel such as for example gelatin or composition comprising functional-gel such as for example gelatin can incorporate and or be combined with one or more nutritional supplements, and especially those reported to have weight loss or energy promoting properties and or benefits. In yet another embodiment of the present invention, the functional-gel such as for example gelatin or composition comprising functional-gel such as for example gelatin can incorporate and or be combined with one or more raw flour; including wheat flour and especially one treated to reduce or eliminate lectins and processed for food safety. In yet another embodiment of the present invention, the functional-gel such as for example gelatin or composition comprising functional-gel can incorporate and or be combined with one or more raw starch including raw cornstarch. In yet another embodiment of the present invention, the functional-gel such as for example gelatin or composition comprising functional-gel such as for example gelatin can incorporate and or be combined with one or more modified starch. In yet another embodiment of the present invention, the functional-gel such as for example gelatin or composition comprising functional-gel such as for example gelatin can incorporate and or be combined with one or more dietary fiber. In yet another embodiment of the present invention, the functional-gel such as for example gelatin or composition comprising gelatin can incorporate and or be combined with one or more functional fiber. In yet another embodiment of the present invention, the functional-gel such as for example gelatin or composition comprising functional-gel such as for example gelatin can incorporate and or be combined with one or more natural or synthetic gum. In yet another embodiment of the present invention, the functional-gel such as for example gelatin or composition comprising functional-gel such as for example gelatin can incorporate and or be combined with one or more modified carbohydrate, especially slowly digestible and low glycemic carbohydrates. In yet another embodiment of the present invention, the functional-gel such as for example gelatin or composition comprising functional-gel such as for example gelatin can incorporate and or be combined with one or more lipase inhibitor or lipase sequestrant. In yet another embodiment of the present invention, the functional-gel such as for example gelatin or composition comprising functional-gel such as for example gelatin can incorporate and or be combined with one or more of chia seed, chitosan, alginate, psyllium or other colloidal agent. In yet another embodiment of the present invention, the functional-gel such as for example or composition comprising gelatin can incorporate or be combined with one or more bile salt inhibitor or bile salt sequesterant or hypolipidemic agents, for example but not limited to Maalox (aluminum hydroxide and magnesium hydroxide), Carafate (sucralfate), and Questran (cholestyramine), Colesevelam (Cholestagel in Europe, Welchol in the USA), Colestipol (Colestid) Colestipid.

Other objects and advantages will be more fully apparent from the following disclosure and appended claims.

### Compositions

### Introduction

The following examples are illustrative purposes only and are not intended to limit the scope of the present invention. Unless otherwise mentioned all parts and percentages are by weight (w/w). Functional-gel or compositions comprising a functional-gel may be formulated into many edible products. As used in the context of the present invention, “edible product” is intended to have a broad meaning and encompasses formulated edible products such as a foods, beverages, supplements, medicaments, nutritionals or other types of preparations. As used in the context of the present invention, the term “functional-gel” is inclusive of the term gelatin. It will be recognized, however, that the invention is not limited thereto and that the formulations can be varied to provide many product types and accommodate many users and markets and that the processes for preparation may be modified to provide for more efficient and/or automated operation. The embodiments of the present invention may, of course, be carried out in other ways than those set forth herein without departing from the spirit and scope of the invention. The present embodiments are therefore to be considered in all respects as illustrative, non limiting, not restrictive and that all changes and equivalents also come within the description of the present invention. The following no limiting Examples will further illustrate the present invention

Among the non limiting edible product examples are include meal replacements, nutritional bars, functional ingredient products and confections including gelatin deserts and gummies A wide variety of optional ingredients and additives may be incorporated into the compositions comprising a functional-gel of this invention, many of which are listed and described herein but it should be understood that any ingredients and additives known in the art may be used. Among the non limiting examples of ingredient and additives which may be utilized are included various sweeteners, sugar substitutes (including natural and artificial substitutes), dietary fibers, functional fibers, modified starches, gums, hydrocolloids, fruits, vegetables (including their juices, extracts, pastes, pulps, pomaces), spices, proteins, fats, carbohydrates, alcohols, dairy products, plasticizers, preservatives, colorants, flavoring agents, hardeners, antifoggers, bulking agents, sensitizers, humectants, emulsifiers and spreading agents, nutritional supplements, pharmaceuticals, etc

The solvent of any of the compositions listed herein or any other suitable edible product may be water or any other edible aqueous solution including dairy milk and non dairy milk for example soy, rice, hemp, almond, coconut, etc, or fruit juices or vegetable juices, or extracts including those such as a teas, coffees, or beverages such as flavored drinks, soft drinks, soda, tonic, seltzers, etc.

### Without Carrier

In one embodiment of the invention, if desired, the functional-gel may be administered without any carrier. Functional-gel may be in the form of sheets, granules, or powder. Instant types can be added to the food as they are. The functional-gel may simply be ingested directly and or dissolved in water and consumed by the user. Alternatively, the functional-gel may be mixed into a food or sprinkled onto a food, for example but not limited to, soft products such as yogurt, custard, apple sauce, gravies, dressings and sauces or may be dissolved into a beverage such as milk, smoothie, shake, soft drink, juice, tea or coffee, etc.

### Ready Mix

In another embodiment of the invention, if desired, the functional-gel may be formulated with flavorings, colorants, sweeteners and any other suitable additives or ingredients etc to provide a palatable ready mix type product, the ready mix product may used to supplement foods or beverages by the user, alternatively the ready mix can be applied toward the preparation of a gelatin or gummy dessert or candy type products.

As a non limiting example, the basic ingredients of gelatin dessert mixes are gelatin (either Type A or Type B or a blend of both), sweetening agent, which can be a natural sugar, such as sucrose, fructose or dextrose, or an intensive sweetener, such as saccharin, aspartame or acesulfame-K, acid, flavors and colors. Most of these mixes also use buffer salts to help in controlling the pH of the gel, as well as modifying the setting and melting characteristics of the gel. These salts are typically citrates, tartrates and/or phosphates. Sometimes a small amount of sodium chloride is added for flavor enhancement. Gelatin of various Bloom strengths may be used, typically from about 50 to about 300 and more preferably between about 120 to about 275 Bloom, with the amount of gelatin ranging between 4 and 15% by weight in the case of sugar-sweetened mixes, where gelatin is the only gelling agent.

Higher bloom gelatins are preferred for formulations requiring or employing thermo processing including hot fill, retort and pasteurization among others. Higher bloom gelatins are also preferred for compositions that are formulated to be shelf stable, because higher bloom gelatins tend to have higher thermal resistance and higher gel strengths. In one particular embodiment the gelatin may be treated with a transglutaminase to increase its thermal stability and or gel strength. Transglutaminase applications for gelatin are known and practiced in the art and of which may be applied to the present invention.

The functional-gel compositions of the invention may optionally comprise a cold soluble gelatin, as the sole source of gelatin or in combination with traditional gelatin. Cold soluble gelatin dissolves when it comes into contact with a cold liquid (water, milk, fruit juice, etc). As there is no heat involved in the preparation, cold soluble gelatin will immediately impact the viscosity, thickening or air entrapment of the preparation. Such cold soluable gelatin can be produced as described in U.S. patent Ser. No. 07/229,462 which is incorporated herein by reference. Such cold soluble gelatin can be produced as described in U.S. patent Ser. No. 07/229,462 incorporated herein by reference or other methods known in the art.

The functional-gel compositions of present invention may be formulated as a rapidly consumable packaged gel. Gels may be provided as an essentially homogenous composition in a squeezable consumable package like a tooth-paste container to be squeezed directly from the package into the mouth for consumption or may include solids especially coarsely or finally milled solids or a combination of both.

### Example 1

TABLE 8
sugar-free gelatin dessert mixes as shown by the
following example of strawberry-flavored gelatin mix.

| Ingredient | Parts By Weight |
|---|---|
| Gelatin | 4.9 |
| Adipic Acid | 1.68 |
| Disodium Phosphate | 0.495 |
| Trisodium Citrate | 0.495 |
| Aspartame | 0.4 |
| Maltodextrin | 0.3 |
| Flavor/Color | 0.3 |
| Fumaric Acid | 0.108 |

### Example 2

### Gelled Bar

An example of preferred formulation a gelled nutrition bar is provided here as a non limiting example. The gelled nutrition or snack bar is formulated to be single serve, shelf stable, product with similar thermal stability to that of milk chocolate. The Processing Procedure used was as follows: 1) hydration of apple fiber (Now foods apple fiber) in juice (Diet V8 Splash) for 1-2 hour at 4-8° C., 2) hydration of gelatin powder (Superclear) and sugar free gelatin mix (Better Bowls) in juice (Diet V8 Splash) for 30 min at 4-8° C., 3) Heat hydrated gelatin until liquefied above 35° C., 4) Add apple fiber juice suspension (#1 above) to liquefied gelatin (#3 above) and mix, 5) Add previously prepared fruit chunks(optional), 6) Bring mixture to 95° C. for 5 minutes. 7) Place (#6 above) at 4-8° C. for 18+ hours to set. 8) Resulting product has: a) a pH<3.7-3.9, b) consistency of a gummy bear or fruit chew with pulp and a c) melting point similar or better to milk chocolate drops for 30 min at 105° F. A proposed commercial formulation is as follows: Gelatin, fruit pomace, chicory root extract, natural strawberry flavor, citric acid, sodium citrate, sucralose, colored with red beet juice and annato, Vit C (ascorbic acid), Acesulfame K. A proposed commercial processing procedure is a follows: 1) gelatin hydration 4-80 C>30 min 2) pomace hydration 4-80 C>1 hrs 3) dry mix flavorings, acidulents, colorants, sweeteners 4) liquefy gelatin at >35° C., 4) mix 2, 3 and 4 at >350 C 5) VFFS hotfill to flexible pouch or stick with easy tear tab 90-950 C, 6) Place gel bar pouches in shape forming trays to set at 4-80 C for 18+ hrs. The product may be prepared by any suitable commercial processing and filling available including, as an Acidified food, using VFFS—Vertical form fill and seal pouch/sticks, an aseptic and/or Hot Fill processes, or a retort process and preferable an agitated retort process. Example: FSU800 Hot Fill, Fres-co System, Telford, Pa. US Proposed packing for the product is a follows: 1) Presentation: Nutrition bar 2) Type: high barrier pouch/wrapper (example ExxonMobil—Metallyte® film for VFFS), 3) Other: easy tear tab+, 4) Processing: amenable to post-fill in-package molding, 5) Weekly supply—multi bar box

### Example 3

### Gelled Bar for Protein Delivery

Also contemplated a use of functional-gel compositions are gelled compositions useful for the delivery of between 1 and 30 grams but preferable 5, 10, or 20 g or greater amounts of dietary protein or dietary fiber or a combination of both dietary protein and dietary fiber, where the caloric density of the composition may be within the bounds for the present invention or may exceed those bounds as a separate and distinct application for example but not limited to a meal replacement.

### Example 4

### Confections

Various dairy & non dairy desserts and confectionaries known in the art comprise gelatin or can be formulated to comprise gelatin including ice creams, yoghurts, ready-to-eat desserts, mousses, low fat spreads fruit chews and toffees and of course, the typical “gelatin desserts” or table jellies, as well as marshmallows, gummy bears and similar sweets, among others. Gelatin based desserts and candies are well known in the art and are popular with consumers. For example soft gelatin desserts, well known commercially as JELLO®, easily dissolve in the mouth providing a melt-away feel, while desserts known as JELL-O® JIGGLERS™ have a firmer more elastic texture and feel, and an even firmer confection commonly known as GUMMY BEARs™ which have a chewy texture and are shelf stable.

A typical gelatin formulation is comprised of sweeteners, bulking agents, gelling agents, acidulants, colors and flavors. Among the various ways that gelatin formulations can be modified, include using alternate sweeteners, varying gelling-agent and bulking agents, levels and blends, as well as by the addition of gums and starches. The design objective is typically to achieve desirable texture, sweetness, flavor release and storage properties. For example the formulation may be designed to produce refrigerated or shelf stable products or to produce all natural or vegetarian or even vegan varieties. In yet another example the formulation may be varied to provide low sugar or no sugar compositions. Additionally the formulation may be modified to provide a ready-mix powder composition. The compositions of this invention should be construed to include any of these embodiments.

The typical commercial formulations does not deliver sufficient gelatin in a sufficiently low caloric formulation to promote satiety and or weight loss, therefore the formulations known in the art may be modified according to the invention described herein to achieve the desired properties of the functional-gel of the present invention including satiety and weight loss properties.

This invention will be further described below with reference to specific embodiments. It will be recognized, however, that the invention is not limited thereto and that the invention may be employed with any edible product including desserts or confections known in the art. Typically the basic ingredients of the composition include a gelling agent such a gelatin, sweetening agent, which can be a natural sugar, such as sucrose, fructose or dextrose, or an intensive sweetener, such as saccharin, aspartame or acesulfame-K, acid, flavors and colors. Most of these mixes also use buffer salts to help in controlling the pH of the gel, as well as modifying the setting and melting characteristics of the gel. These salts are typically citrates, tartrates and/or phosphates. Sometimes a small amount of sodium chloride is added for flavor enhancement. For a gelatin based formulation, Either Type A or Type B gelatin or a blend of both may be used. Gelatin of various Bloom strengths may be used, typically from 175 to about 275 Bloom range, with the amount of gelatin ranging between 4 and 15% by weight in the case of sugar-sweetened mixes. However, the gelatin content can be varied significantly to produce from a very wiggly soft gelatin desert product to a firmer yet soft product such as Jello® Jigglers, or firmer products such as gummies, or even harder tougher products. The gelatin may be varied from about 3 to 80% by weight of the finished product. Various optional ingredients and food additives can be employed. The amount of gelatin employed in the dry mix is that required to produce a gelled product of acceptable gel or set strength upon hydration of the mix in water or other aqueous medium and after a suitable setting period. The amount will of course vary depending upon the particular type of gelatin employed and the overall characteristics of the hydrated dessert mix (e.g., pH). Generally, however, based upon the weight of the overall dessert (i.e., including the aqueous hydrating medium), the weight percent of gelatin will be in the range of from about 2.0 to about 98%, and more typically, in the range of from about 5 to about 75% by weight and most typically between 6 and 20%.

### Composition Summary

In general, a soft gelatin or gummy composition used to carry out the present invention typically comprises:
a) functional-gel for example gelatin
b) water (or other aqueous solvent)

More typically a food composition, such as a soft gelatin or gummy composition, used to carry out the present invention comprises:
Functional-gel or gelatin and
water (or other aqueous solvent) and
optionally but preferably a sweetener
optionally, but preferably a food flavoring
optionally but preferably a food acid
optionally, any of a food humectant, preservative, gum, hydrocolloid, modified starch, dietary fiber, functional fiber, fruit, vegetable, milk, milk or derivative thereof.

### Composition Ranges

A food composition or nutritional supplement useful for carrying out the foregoing methods typically comprises:
a. about 2 to 98 percent by weight of functional-gel for example gelatin; and
b. about 2 to 98 percent by weight of water;

A food composition or nutritional supplement useful for carrying out the foregoing methods more preferably typically comprises
a. about 2 to 98 percent by weight of functional-gel or for example gelatin; and
b. about 2 to 95 percent by weight of water; and
c. about 0 to 65 percent by weight of sweetener; and
d. about 0 to 15 percent or more by weight of food flavoring; and
e. about 0 to 4 percent or more by weight of food acid;

The food composition or nutritional supplement useful for carrying out the foregoing methods may also comprise:
a. about 0 to 5 percent or more by weight of preservative; and
b. about 0 to 4 percent or more by weight of food coloring; and
c. about 0 to 25 percent or more by weight of humectant; and
d. about 0 to 25 percent or more by weight of food gum; and
e. about 0 to 25 percent or more by weight of hydrocolloid; and
f. about 0 to 60 percent or more by weight of bulking agent; and
g. about 0 to 40 percent or more by weight of dietary fiber; and
h. about 0 to 40 percent or more by weight of functional fiber; and

Numerous other ingredients, additives, supplements and the like can also be included in the composition, as desired, including but not limited to proteins, carbohydrates, fats, amino acids, alcohols, modified starches, emulsifiers, fruits, vegetables, juices, pulps, concentrates, milk, milk derivates, dairy products etc.

### Procedure

The gelatin confection may be prepared by any suitable procedure. One procedures for making the gelatin confections known in the art which may be employed is as follows: Gelatin powder is soaked at room temperature in about ⅔ of the formula water for about 30 minutes. Sweeteners and optionally glycerine and the balance of the water are separately mixed and heated until the sweeteners are fully dissolved. The gelatin slurry and heated solution are then mixed and heated to a temperature of 220° F. and allowed to cool to about 170° F. The top layer of the mixture may be skimmed off in order to improve the clarity of the gelatin confection. Flavor, color and acid components are then added to the clarified solution and this solution is then deposited into impressions made in a bed of powdered starch. Typically this starch will have a moisture content of about 6 to 8%. The gelatin solution is allowed to cure over a period of 3 to 36 hours at temperature of from 35° F. to 70° F. to per desired texture with shorter times and lower temperatures giving softer texture and longer times and higher temperatures giving firmer textures. After curing, the pieces are removed from the starch impressions, sprayed with warm water and/or steam in order to remove from the surface any solubilized or adhering starch and then immediately coated with a blend of oil (e.g., vegetable oil) and/or wax (e.g., carnauba and/or bees wax). The pH may be adjusted by the addition of suitable acid, buffer, or both. The pH of the composition is about 3 to about 5, preferably about 3.7 to about 4. The pH may be adjusted by any suitable acid, buffer, or both. Suitable acids include but are not limited to citric, adipic, malic, and lactic. Suitable buffers include but are not limited to sodium citrate and potassium citrate. The products will optionally have a solids content of from 63 to 72% and an Aw of from 0.75 to 0.85. The composition may be formulated to have very good heat stability, to withstand extended storage at above 40° C., typically at least up to 50° C. Without limitation, other ingredients may used to prepare the gelatin dessert or gummy composition including but not limited to, colorant(s), flavorant(s)s, sweetener(s), mint(s), fragrance(s), active ingredient(s), plasticizer(s), bulking agent(s), whipping aid(s), and mixtures thereof

### Example 5

A room-temperature stable, gelled, gelatin confection having a solids content of from 63 to 72%, an Aw of 0.65 to 0.85, and a pH of from 2.0 to 4.6, said confection being comprised of 3 to 20% gelatin or gelling agent, 20 to 40% water, 30 to 45% dietary fiber, 3 to 10% sweetener, 2 to 6% humectant and 0.5 to 4% food acid.

### Example 6

A room-temperature stable, gelled, gelatin confection having a solids content of from 63 to 72%, an Aw of 0.65 to 0.85, and a pH of from 2.0 to 4.6, said confection being comprised of 3 to 20% gelatin or gelling agent, 20 to 40% water, 30 to 45% dietary protein, 3 to 10% sweetener, 2 to 6% humectant and 0.5 to 4% food acid.

### Example 7

A room-temperature stable, gelled, gelatin confection having a solids content of from 63 to 72%, an Aw of 0.65 to 0.85, and a pH of from 2.0 to 4.6, said confection being comprised of 3 to 20% gelatin or gelling agent, 20 to 40% water, 10 to 45% dietary protein, 10 to 45% dietary fiber, 0.5 to 20% sweetener, 2 to 6% humectant and 0.5 to 4% food acid.

### Example 8

A room-temperature stable, gelled confection having a solids content of from 63 to 72%, an Aw of 0.65 to 0.85, and a pH of from 2.0 to 4.6, said confection being comprised of 1 to 5% carageenan (nu-carageenan or nu/iota-carageenen or both), 0.25 to 1% gellan gum, 20 to 40% water, 10 to 45% dietary protein, 10 to 45% dietary fiber, 0.5 to 20% sweetener, 2 to 6% humectant and 0.5 to 4% food acid.

### Example 9

Shelf Stable gelled confection or bar, said composition being comprised of 74.2% water, 17.3% protein, 0.5% Malic Acid, 1.8% carrageenan, 0.5% Carob Bean Gum, 0.8% flavoring, 0.9% Potassium citrate, 1.8% L-tryptophan, 0.2% sucralose, 0.9% Potassium Sorbate, 0.1 Sodium Benzoate, 0.9% Acesulfame Potassium, by finished product % weight. Service size 113 g, Calories per serving 90.7 (kcal), Caloric Density 0.78 (kcal/g)., protein per serving 19.51 g.

### Example 10

A Fruit leather like confection or bar, said composition comprised of 54.9% water, protein 31.4%, Glycerin 9.8%, Sorbitol liquid 3.1%, Propylmethyl Paraben 0.2%, color and flavoring 0.59%. on finished product basis. Serving size 50 g, Calories per serving 86.4 (kcal), Energy density 1.73 (kcal/g), protein per serving 15.7 g.

### Example 11

Cooked or raw starch is mixed with the hydrated gelatin at ratios ranging from about 3 to 60 percent of starch or flour and about 97 to 40 percent of gelatin, by weight, based on the total solids, and the solution is held at about 137 F (58 C) for at least 16 hours. The gelatin component is prepared by suspending the desired amount in cold water and then heating the suspension at about 140 F. (60 C) under moderate stirring until completely dispersed. The cooked starch component is prepared by cooking a slurry of the desired amount of the starch at between 200 and 212 F. (99-100 C.) for about 20 minutes and then cooling the cook to about 140 F (60 C) prior to admixing with gelatin. Alternatively, raw starch slurry may be substituted for cooked starch. In any instance the quantities of the starch and the gelatin are in reciprocal amounts such that the total solids is about 30 percent, by weight, of the final solution. Following the holding period compatibility and stability are evaluated based on a visual examination of the solution. Preferred as gelatin compositions according to this invention are those starch gelatin mixtures which yield a test solution free from any phase separation or sediment.

### Example 11

### Gelatin Cross Linked with Transglutaminase

13 grams of Gelatin Type A, 225 Bloom, was hydrated in 120 mL filtered water at 4-8° C. for 30 minutes, then the gelatin was dissolve at 50° C. and the pH was adjusted to about 6, transglutaminase (ActivaT1/RM) was added at various concentrations: 0, 0.12, 0.25, 0.50, 1, 2 and 3% of gelatin on % w/w basis (ug/ml: 0, 35, 70, 140, 280, 560, 1200) and incubate at 50° C. for 20, 40, 60, 120 min, then adjust pH to 3.0-3.3 and thermally treatmented samples at 90-95° C. for 3 min then allowed them to cool to 82-85° C. for 2-5 min and allowed to cool to room temp for 30 min and then placed at 4-8° C. for 18 hours to allow the samples to set to full firmness. The result was a series of gelatin formulations with increased firmness and increased thermal resistance and varying crumble and chew texture as compared to untreated samples. Cross-linked gelatin is to shelf stable thermal food processing and for increasing its melting point to that of non gelatin based gelled products such as for example pectin, carageenan and agar.

### Example 12

### Nutritional Bars

Nutritional bars and snack bars are popular with consumers. The present functional-gel composition of the invention may be incorporated into nutritional and snack bars. In general, a food composition nutritional bar or snack bar compositions comprises:
functional-gel
optionally, but preferably, a complex carbohydrate which is slowly absorbed from the human gastrointestinal tract (hereinafter “slowly absorbed carbohydrate”), i.e., is slowly digested and is not completely metabolized even after 3-4 hours;
optionally, but preferably, a complex carbohydrate which is more rapidly absorbed from the digestive tract (hereinafter “rapidly absorbed carbohydrate”);
optionally, but preferably, protein;
optionally, but preferably, fat; and
optionally, but preferably, at least one sweetening agent.

A food composition useful for carrying out the foregoing methods typically comprises:
about 2 to 95 percent by weight of functional gelatin; and optionally any of the following:
about 10 to 75 percent by weight of slowly absorbed complex carbohydrate;
about 10 to 75 percent by weight of rapidly absorbed complex carbohydrate;
about 2 to 40 percent by weight protein;
about 2 to 40 percent by weight fat; and
at least one sweetening agent in an amount effective to sweeten said food composition.

Numerous other additives, supplements and the like can also be included in the composition, as desired. In one embodiment, the snack or nutritional bar composition preferably contains 2-35 grams of functional-gel, and about 20 to about 50 grams of nutrients per serving unit, e.g., per bar, including; about 15-35 grams of total complex carbohydrates (about 5-15 grams of slowly absorbed complex carbohydrate, about 7-20 grams of rapidly absorbed complex carbohydrate and about 0-15 grams of simple sugar, sugar alcohol, sugar substitute or combination thereof; about 2-30 grams of protein; and about 2-7 grams of fat). The ingredients in the food composition may include any conventional food ingredients of adequate purity and wholesomeness which preferably supply the desired amounts of functional-gelatin, total calories and percentage of calories from carbohydrates, protein and fat, respectively, and wherein the relative weight ranges of slowly absorbed carbohydrates, rapidly absorbed carbohydrates, protein, fat, sweetener and functional-gel are as indicated previously.

In one preferred embodiment of snack or nutritional bar, the ingredients may include, by way of illustration, functional gel, slowly absorbed carbohydrate; polydextrose, peanuts, peanut derivatives (e.g., peanut butter), other nuts or nut derivatives as sources of rapidly absorbed carbohydrates, fat and protein; and other protein sources such as soy protein, whey protein, and casein hydrolysate among others. Coloring agents, water, salt, preservatives and other standard ingredients or additives normally used in the preparation of snack or candy-type bar may be utilized, as well as simple sugars including fructose and others (e.g., sucrose, lactose or galactose). Artificial sweeteners (e.g., aspartame or saccharine or sucralose) may be included in the food compositions as well as sugar alcohols such as for example sorbitol and maltitol, provided that the total nutrient and calorie profile of the finished bar or other form of the novel food composition comes within the parameters defined above. The food composition may have a weight of 10 to 200 grams or greater, depending upon the manner of packaging and intended manner of administration.

### Pharmaceutical Formulation

Also, the functional-gel compositions can be incorporated into a pharmaceutical or food grade composition of the form customarily employed for oral administration. Pharmaceutical or food grade compositions containing the functional-gel composition may be in liquid or semi liquid form, for example, a solution, a suspension, a gel, a slurry or an emulsion specifically adapted for oral administration or in solid form, for example, a tablet, capsule, pill, lozenge, powder or packaged powder or packaged powder matrix.

Methods for preparing such dosage form are well known in the art. The reader's attention is directed to the most recent edition of Remingtons Pharmaceutical Sciences for guidance on how to prepare such dosage forms. Of particular interest are formulations which may be applied toward preventing the hydrating and gelling of functional-gel prior to entering the user's gastrointestinal tract. Advantageously, the pharmaceutical or food grade composition containing the functional-gel composition can be prepared in unit dosage form using Pharmaceutically or food grade acceptable carriers, such as for example starch, glucose, lactose, gelatin, sucrose, etc., and the like. If desired, the dosage unit can be made up in a sustained release form to give a controlled dosage over an extended period of time. Also, if desired, the dosage unit can be made up in an form to give a controlled dosage release in the intestine. Such pharmaceutical or food grade composition can include various carriers and additives as known in the art and can include various sweetening or flavoring agents to improve palatability. Methods known in the arts of controlled release and enteric coatings, as well as the materials employed in the arts commonly known as pharmaceutical excipients can be readily employed in the formulation of the compositions. Various excipients known in the art may be used in the manufacture and formulation of functional-gel compositions, including but not limited to: Primary excipients: eluents (fillers), binders (adhesives), disintegrants, lubricants, antiadhesives, glidants; Secondary excipients: coloring agents, flavors, sweetners, coating agents, plasticizers, wetting agents, buffers, absorbents, waxes.

### Dosage Forms

The functional-gelatin compositions can be formulated as, solutions, suspensions or emulsions, so that they can be delivered in a soft drink or beverage, such as water, juice, shake, smoothie, milk, soda or semi solid foods as for example ice cream, creams, yogurts, custards, frostings, sauces or any other suitable form or vehicle. An advantage of this delivery method is that it provides the ability to deliver higher doses in a palatable vehicle. The functional-gel composition may also be formulated as a gelatin dessert, or confectionery such as a gummy, candy or bar, meal replacement, powder mix, or any other suitable formulation.

### Hydrated or Dehydrated

Functional-gel and compositions comprising a functional-gel may be used in dehydrated, hydrated or partially hydrated form or any combination thereof. In a dehydrated or partly dehydrated form the functional-ge composition may be hydrated by the user prior to user ingestion. For example, functional-gel may be added in the form of a powder into a smoothie, shake, or beverage, or soft food such as a yogurt, pudding, jam etc where it will fully or partly hydrate prior to its consumption. Alternatively, it may be incorporated into a food or food product in a previously hydrated or partially hydrated form. Furthermore a dehydrated or partly dehydrated form of functional-gel or composition comprising a functional-gel may be protected by a coating or by any other suitable method to prevent its hydration prior to ingestion by the user. The dehydrated and protected functional-gel will then be released in the gastrointestinal tract of the mammal which ingested it, where it can hydrate within the aqueous environment of the GI. Furthermore the protected composition of this invention may be formulated to hydrate in the stomach or the intestine of the mammal for example by use of an appropriate controlled release or enteric formulation. Furthermore the composition of this invention may additionally be formulated to increase its solubility in beverages and aqueous foods, while preventing it from gelling or reducing its gelling properties within the beverage, but allowing hydration and full gelling to take place within the gastrointestinal tract of the user.

The functional-gel or composition comprising functional-gel may be in the form of instentized functional-gel which dissolves in cool water per. The functional-gel or composition comprising functional-gel may be incorporated into a cool drink or beverage or food. The functional-gel or composition, may be delivered in a warm or hot beverage or food including for example in a dissolved form. The functional-gel or composition comprising functional-gel may be in a macro sized form for example similar to boba tea or in a nano- or micro-sized functional-gel composition.

### Food Product Manufacturing

### Non-Limiting Examples of the Present Invention

The following are non limiting examples of a manufacturing processes, practices and methods that may be applied to the present invention. The compositions can be prepared utilizing conventional processes or the processes described herein. One knowledgeable in the arts would be able to select one of the many manufacturing processes available to produce the desired final product. The examples are provided to illustrate the invention and are not intended to limit the scope thereof in any manner. The composition of this invention may, be fabricated by any known method in the art and practiced by a person skilled in the art of pharmaceutical drug delivery, and food science including food encapsulation, food processing, etc.

The compositions of this invention may be fabricated, formulated or created by any method known in the art and, practiced by al person skilled in the art including but not limited to extrusion, chilsonation, micronizing, granulation, roll compaction, spray-drying, agglomeration, fluid bed coating, spray-chilling/cooling, melt injection, melt extrusion, emulsification, preparation of emulsions with multilayers, Coacervation, preparation of microspheres via extrusion or dropping, Preparation of microspheres, nanoparticles or nanolipids, or nanoencapsulates can be done via any method known in the art by any person skilled in the art including but not limited to emulsification, co-extrusion, inclusion complexation, liposome entrapment, encapsulation can be achieved by any method known in the art including by rapid expansion of supercritical fluid (RESS), freeze-drying, or vacuum drying. The Gelatin composition may be formulated into capsules, microcapsules, tablets, micro tablets, spheroids, micro spheroids, pellets, granules, or any other formulation known in the art including, pharmaceutical, food and beverage formulations

### Liquid Compositions

The products/compositions of this invention can be manufactured using techniques well known to those skilled in the art. For liquid meal replacement products, generally speaking, an oil and fiber blend is prepared containing all oils, any emulsifier, fiber and the fat soluble vitamins. Three more slurries (carbohydrate and two protein) are prepared separately by mixing the carbohydrates and minerals together and the protein in water. The slurries are then mixed together with the oil blend. The resulting mixture is homogenized, heat processed, standardized with water soluble vitamins, flavored and the liquid terminally sterilized or dried to produce a powder. Alternatively, the homogenized formula may be kept undiluted and filled into appropriate containers as pudding or dried to form powder. The product is then packaged. Typically the package will provide directions for use by the end consumer (i.e. to be consumed by a diabetic, to assist with weight loss, etc.)

### Purification/Sterilization

Appropriate purification or sterilization procedures can be employed to provide a potable or sterile pharmaceutical or food grade composition fit for human consumption. Purification procedures can be used to remove impurities. The preparation procedures can include isolation and purification procedures to insure standard uniform composition and physical form within specified tolerances in order to provide uniform quality, strength, effectiveness, and other properties, as well as procedures to insure food grade or pharmaceutical grade purity.

Any suitable microbial decontamination methods and practices from the pharmaceutical and or from the food industry may be used, including but not limited to: non-chemical and non-thermal decontamination methods such as high hydrostatic pressure, pulsed electric fields, irradiation, power ultrasound and non-thermal plasma. Thermal methods such as microwave, radio-frequency and infrared heating and food surface pasteurization may also be used. Chemical decontamination methods with ozone, chlorine dioxide, electrolyzed oxidizing water, organic acids and dense phase CO2, etc.

### Other Ingredients

### Introduction

A wide variety of optional materials including nutrients, ingredients and additives and medicaments, may be incorporated into the gelatin compositions of this invention. A useful material must be compatible with gelatin and stable in mixtures with gelatin, and must not impair the properties of the gelatin per the invention as described herein. Any conventional material including food ingredient(S) and or food additive(S) of adequate purity and wholesomeness may be used. The materials for the present invention may be of any source or blend available for human consumption. Any of the materials listed herein, may be used in any amount and combination that is appropriate for the practice of the present invention. Variations in materials, proportions, and procedures maybe made without departing from the scope and spirit of this invention as described herein. The various materials are well known by those skilled in the art and can be readily selected when preparing such products. Commercial sources are readily available and known to one practicing in the art. Included among the prominent nutrients which may be utilized are carbohydrates, proteins, fats, alcohols, vitamins and minerals. Included among the prominent ingredients which may be utilized are complex carbohydrates, fiber, gums, hydrocolloids, sweeteners, artificial sweeteners, natural sugar substitutes, modified starches, flours, fruits and vegetables, and their juices, extracts and derivates a as well as dairy products. Included among the prominent additives which may be utilized are plasticizers, preservatives, colorants, flavorings, hardeners, antifoggers, sensitizers, extenders, and spreading agents. The USDA report titled Dietary Reference Intakes: The Essential Guide to Nutrient Requirements the essential guide to nutrient requirements, 2006 Institute of Medicine, of the National Academies. National Academy Press, Washington D.C., and materials therein listed and or described are incorporated by reference herein. The term “nutrients” as used herein refers to carbohydrates, proteins and fats and any other material with nutritive, dietary or functional value.

### Carbohydrates

Among the materials suitable for use in the practice of the present invention are carbohydrates. Carbohydrates (saccharides) are divided into four chemical groups: monosaccharides, disaccharides, oligosaccharides, and polysaccharides all of which may be used. The carbohydrate source may be provided by any source suitable for humans, taking into account any relevant dietary restrictions. Examples of suitable carbohydrates that may be utilized include but are not limited to starch, modified starch, hydrolyzed corn starch, maltodextrin, glucose polymers, sucrose, corn syrup solids, glucose, fructose, lactose, high fructose corn syrup, fructooligosaccharides, honey, dietary fiber, functional fiber, sugar alcohols (e.g. malitol) etc. Specialized carbohydrate blends have been designed for diabetics to help moderate their blood glucose levels. Examples of such carbohydrate blends are described in U.S. Pat. No. 4,921,877 to Cashmere et al, U.S. Pat. No. 5,776,877 to Wibert et al, U.S. Pat. No. 5,292,723 to Audry et al. and U.S. Pat. No. 5,470,839 to Laughlin et al, the contents of which are all incorporated by reference. Any of these carbohydrate blends may be utilized to reduce glycemic index of the product. May also include flours Flour is a powder which is made by grinding cereal grains, beans, or other seeds or roots. The flours may be raw, partially cooked or fully cooked and/or processed for microbial decontamination or control and processed for elimination, reduction or neutralization of lectins. Any flours listed in http://en.wikipedia.org/wiki/Flour 2014 are incorporated herein by reference.

### Complex Carbohydrates

Among the materials suitable for use in the practice of the present invention are complex carbohydrates. The term “complex carbohydrate” as used herein refers to macromolecular carbohydrates including starches, modified starches, fibers, polydextrose (i.e. Litasse® Dupont) and other polysaccharides. The complex carbohydrate source for the present invention may be any source or blend of sources available for human consumption. Examples of sources of complex carbohydrates which can be used in the practice of the present invention include but are not limited to nuts, barley, bulger, pasta, parboiled rice, dried legumes, uncooked cornstarch, uncooked flours or mixtures thereof and modified starches. Complex carbohydrates are well known by those skilled in the art and can be readily selected when preparing such products. Commercial complex carbohydrate sources are readily available and known to one practicing in the art.

### Sweetening Agents

Among the materials suitable for use in the practice of the present invention are sweetening agents. The term “sweetening agent” refers to simple sugars (e.g, sucrose, lactose, galactose and fructose), sugar alcohols (e.g., sorbitol or maltitol, erythritol, etc) and artificial sweeteners (e.g. aspartame, sodium saccharin, and acesulfame potassium, sucralose) or any other artificial or natural sugar substitutes (e.g. stevia etc.) known in the art.

### Sugar Alcohols

Among the materials suitable for use in the present invention are sugar alcohols. A sugar alcohol are organic compounds, a class of polyols, also called polyhydric alcohol, polyalcohol, or glycitol typically prepared from sugars. They are white, water-soluble solids that occur naturally and are used widely in the food industry as thickeners and sweeteners. In commercial foodstuffs, sugar alcohols are commonly used in place of table sugar (sucrose), often in combination with high intensity artificial sweeteners to counter the low sweetness. Among the sugar alcohols that may be used are methanol, ethylene glycol, glycerol, erythritol, threitol, arabitol, xylitol, ribitol, mannitol, sorbitol, galactitol, fucitol, iditol, inositol, volemitol, somalt, maltitol, lactitol, maltotriitol, maltotetraitol, and polyglycito, etc The sugar alcohol source for the present invention may be any source or blend of sources available for human consumption. Sugar alcohols are well known by those skilled in the art and can be readily selected when preparing such products. Commercial sugar alcohols sources are readily available and known to one practicing in the art.

### Artificial Sweeteners and Sugar Substitutes

Among the materials suitable for use in the practice of the present invention are artificial sweeteners and natural sugar substitutes. Artificial sweeteners and natural sugar substitutes may also be added to the compositions of the invention to among other things enhance the organoleptic quality of the formula. Examples of artificial sugar substitutes include Acesulfame potassium, Alitame, Aspartame, Salt of aspartame-acesulfame, sodium cyclamate, Dulcin, Glucin, Neohesperidin dihydrochalcone, neotame, Saccharin, Sucralose. Examples of natural sugar substitutes include: Brazzein, Curulin, Erythritol, Glycyrrhizin, Glycerol, Hydrogenated starch hydrolysates, Inulin, Isomalt, Lactitol, Mogroside mix, Mabinlin, Malitol, Malto-oligosaccharide, Mannitol, Miraculin, Monatin, Monellin, Osladin, Pentadin, Sorbitol, Stevia, rebaudioside A, Tagatose, Thaumatin, and Xylitol. The sugar substitute source for the present invention may be any source or blend of sources available for human consumption. Natural sugar substitutes are well known by those skilled in the art and can be readily selected when preparing such products. Commercial natural sugar substitutes sources are readily available and known to one practicing in the art. The artificial sweetners source for the present invention may be any source or blend of sources available for human consumption. Artificial sweeteners are well known by those skilled in the art and can be readily selected when preparing such products. Commercial artificial sweeteners sources are readily available and known to one practicing in the art.

### Lipids

Among the materials suitable for use in the practice of the present invention are Lipids (i.e., oils, fats). The lipid source for the present invention may be any lipid source or blend of lipid sources available for human consumption. Typically the lipid provides the desired levels of saturated, polyunsaturated and monounsaturated fatty acids. One skilled in the art can readily calculate how much a fat source should be added to the composition in order to deliver the desired levels of saturated, polyunsaturated and monounsaturated fatty acids. Examples of food grade lipids are well known in the art and typically include soy oil, olive oil, marine oil, sunflower oil, high oleic sunflower oil, safflower oil, high oleic safflower oil, fractionated coconut oil, cottonseed oil, corn oil canola oil palm oil, palm kernel oil, flax seed oil, medium chain triglycerides (MCT) and mixtures thereof. If desired, structured lipids can be incorporated into the product. The lipid source may comprise a mixture of medium chain triglycerides (MCTs) and long chain triglycerides (LCTs). Examples of suitable MCT sources include coconut oil, macadamia oil, palm oil, palm kernel oil, or mixtures thereof. Examples of suitable LCT sources canola oil, safflower oil, sunflower oil, corn oil, olive oil, menhaden oil, evening primrose oil, peanut oil, or mixtures thereof. The lipid source may be added to the product in the amount sufficient to delay gastric emptying. Additional sources of MCTs and LCTs are discussed in U.S. Pat. No. 4,703,062, which is herein incorporated by reference. Lipids are well known by those skilled in the art and can be readily selected when preparing such products. Commercial lipid sources are readily available and known to one practicing in the art.

### Vitamins

Among the materials suitable for use in the practice of the present invention are vitamins and minerals. Vitamins and minerals are understood to be essential in daily diet. Those skilled in the art appreciate that minimum requirements have been established for certain vitamins and minerals that are known to be necessary for normal physiological function. Practitioners also understand that appropriate additional amounts of vitamin and mineral ingredients need to be provided to nutritional compositions to compensate for some loss during processing and storage of such compositions. Additionally the practitioner understands that certain micronutrients may have potential benefits for people with diabetes such as chromium, carmitine, taurine and Vitamin E and that higher dietary requirements may exist for certain micro nutrients such as ascorbic acid due to higher turnover in people with type 2 diabetes

As a non limiting example the vitamin and mineral system for a complete nutritional product used as sole source of nutrion typically comprises at least 100% of the RDI for the vitamins, A, B1, B2, B6, B12, C, D, E, K, beta-carotene, Biotin, Folic Acid, Pantothenic Acid, Niacin, and Choline; the minerals calcium, magnesium, potassium, sodium, phosphorous, and chloride, the trace minerals iron, zinc, manganese, copper, and iodine; the ultra trace minerals chromium, molybdenum, selenium, and conditionally essential nutrients ninositol, carnitine and taurine.

As a non limiting example, the vitamin and mineral system for a nutritional product used as a nutritional supplement typically comprises at least 25% of the RDI for the vitamins, A, B1, B2, B6, B12, C, D, E, K, beta-carotene, Biotin, Folic Acid, Pantothenic Acid, Niacin and Choline; the minerals calcium, magnesium, potassium, sodium, phosphorous, and chloride; the trace minerals iron, zinc, manganese, copper, and iodine; the ultra trace minerals chromium, molybdenum, selenium, and the conditionally essential nutrients minositol, carmitine and taurine.

The vitamin and mineral source for the present invention may be any source or blend available for human consumption. Vitamins and minerals are well known by those skilled in the art and can be readily selected when preparing such products. Commercial vitamin and mineral sources are readily available and known to one practicing in the art.

### Flavorings

Among the materials suitable for use in the practice of the present invention are flavorings. The compositions of the present invention will also desirably include a flavoring and/or color to provide the products with an appealing appearance and an acceptable taste for oral consumption. Flavorings include natural flavoring substances, that is flavoring substances obtained from plant or animal raw materials, by physical, microbiological or enzymatic processes. They can be either used in their natural state or processed for human consumption, but do not contain any nature-identical or artificial flavoring substances. Flavorings include nature-identical flavoring substances, that is flavoring substances that are obtained by synthesis or isolated through chemical processes, which are chemically and organoleptically identical to flavoring substances naturally present in products intended for human consumption. They do not contain any artificial flavoring substances. Flavorings include artificial flavoring substances, that is flavoring substances not identified in a natural product intended for human consumption, whether or not the product is processed. These are typically produced by fractional distillation and additional chemical manipulation of naturally sourced chemicals, crude oil or coal tar. Although they are chemically different, in sensory characteristics are the same as natural ones. Of the three chemical senses, smell is the main determinant of a food item's flavor. Any of the seven basic tastes may be used, including sweet, sour, bitter, salty, umami (savory), pungent or piquant, and metallic.

Examples of useful flavorings typically include but are not limited to for example, strawberry, peach, butter pecan, chocolate, banana, raspberry, orange, blueberry and vanilla. Flavoring can be in a form of flavored extracts, volatile oils, chocolate flavoring, peanut butter flavoring, cookie crumbs, vanilla or any commercially available flavoring. For example, if flavoring which contains fat is used (e.g., chocolate flavoring contains butter fat), the fat concentration of the composition of the invention should be adjusted accordingly so that the final fat concentration remains the same, i.e., the final fat concentration does not exceed the desired fat content

The U.S. Code of Federal Regulations describes a “natural flavorant” as: the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional, all which are incorporated by reference herein

Susheela Raghavan, Handbook of Spices, Seasonings, and Flavorings, Second Edition (Google eBook) CRC Press, Oct. 23, 2006—Technology & Engineering—330 pages, incorporated fully herein by reference. The flavoring source for the present invention may be any source or blend available for human consumption. Flavorings are well known by those skilled in the art and can be readily selected when preparing such products. Commercial flavoring sources are readily available and known to one practicing in the art.

### Preservatives

Among the materials suitable for use in the practice of the present invention are Preservatives. Preservatives may be antimicrobial preservatives, which inhibit the growth of bacteria or fungi, including mold or they can be antioxidants such as oxygen absorbers, which inhibit the oxidation of food constituents. Common antimicrobial preservatives include sorbic acid and its salts, benzoic acid and its salts, calcium propionate, sodium nitrite, sulfites (sulfur dioxide, sodium bisulfite, potassium hydrogen sulfite, etc.) and disodium EDTA.[2][3] Antioxidants include BHA, BHT, TBHQ and propyl gallate.[2] Other preservatives include ethanol and methylchloroisothiazolinone. Preservatives such as potassium sorbate, sodium sorbate, potassium benzoate, sodium benzoate or calcium disodium EDTA may be used. Natural food preservatives may be used including substances such as rosemary extract, hops, salt, sugar, vinegar, alcohol, and citric, scorbic acids, vitamin C and vitamin E.

The preservative source for the present invention may be any source or blend available for human consumption. Preservatives are well known by those skilled in the art and can be readily selected when preparing such products. Commercial preservative sources are readily available and known to one practicing in the art.

### Excipients

Among the materials suitable for use in the practice of the present invention are excipients. An excipient may serve as a bulking agents, fillers, or diluents. They also can serve various therapeutic-enhancing purposes, such as facilitating absorption or solubility, or other pharmacokinetic considerations. Excipients can also be useful in the manufacturing process, to aid in the handling of the active substance concerned such as by facilitating powder flowability or non-stick properties, in addition to aiding in vitro stability such as prevention of denaturation over the expected shelf life. Methods known in the arts of controlled release and enteric coatings, as well as the materials employed in the arts commonly known as pharmaceutical excipients can be readily employed in the formulation of the compositions. Various excipients known in the art may be used in the manufacture and formulation of gelatin compositions, including but not limited to: Primary excipients: eluents (fillers), binders (adhesives), disintegrants, lubricants, antiadhesives, glidants; Secondary excipients: coloring agents, flavors, sweeteners, coating agents, glazing agents, plasticizers, wetting agents, buffers, absorbents, preservatives, waxes

Of particular significance are materials and methods known in the art of enteric coatings and controlled drug release which can be employed to produce capsules or coatings with properties consistent with the invention as described herein. For example, methyl acrylate-methacrylic acid copolymers, cellulose acetate succinate, hydroxy propyl methyl cellulose phthalate, hypromellose phthalate, hydroxy propyl methyl cellulose acetate succinate (hypromellose acetate succinate), cellulose acetate phthalate, cellulose acetate trimelliate, Phtalates, polyvinyl acetate phthalate (PVAP), methyl methacrylate-methacrylic acid copolymers, sodium alginate and stearic acid, Eudragit, shellac, hydroxy propyl methyl cellulose, or any other enteric coating and sustained release materials known and available in the art. Methods known in the arts of controlled release and enteric coatings, as well as the materials employed in the art commonly known as pharmaceutical excipients can be readily employed in the construction of the exterior capsule of the gelatin composition

In one embodiment of the present invention, the composition makes use of enteric materials used in colon targeting formulations which are designed to allow for transit through the upper GI and disintegrate in the large intestine, as for example but not limited to natural polysaccharides, various Eudragil formulation with pH sensitive above 4.5, Eudragil L100, Eudragil S, Eudragil FS 30D, Polyvinyl acetate phthalate, Hydroxy propyl methyl cellulose phthalate, cellulose acetate trimelliate, Cellulose acetate Phthalates, starch among others known in the art. Natural polysaccharides as polymers for enteric and colon delivery include but are not limited to chitosan, pectin, guar gum, chondroitin sulphate, dextran almond gum, locust bean gum, cyclodextrins, inulin, boswellia gum, khaya gum etc.

### Emulsifiers

Among the materials suitable for use in the practice of the present invention are emulsifiers. The emulsifiers that are used commercially come from both natural and synthetic sources. They include: Lecithins (E322) are mixtures of phospholipids such as phosphatidyl choline and phosphatidyle-thanolamine, and are usually extracted from sources such as egg yolk and soybeans. The precise composition of the phospholipids depends on the source. Uses include salad dressings, baked goods and chocolate. Esters of monoglycerides of fatty acids (E472a-f) are made from natural fatty acids, glycerol and an organic acid such as acetic, citric, lactic or tartaric. The fatty acids are usually from a vegetable source, though animal fats can be used. Products that use them include ice cream, cakes and crisps. Mono- and diglycerides of fatty acids (E471) are semi-synthetic emulsifiers made from glycerol and natural fatty acids, which can be from either plant or animal sources. They are used in products like breads, cakes and margarines. The emulsifier source for the present invention may be any source or blend of sources available for human consumption. Emulsifiers are well known by those skilled in the art and can be readily selected when preparing such products. Commercial emulsifier sources are readily available and known to one practicing in the art. The EFEMA index of food emulsifiers—June 2013 Edition incorporated herein by reference.

### Humectants

Among the materials suitable for use in the practice of the present invention are humectants. Examples of some humectants include: glycerine, mannitol, sorbitol, propylene glycol (E1520), hexylene glycol, and butylene glycol, glyceryl triacetate (E1518), Sugar alcohols/sugar polyols: glycerol/glycerin, sorbitol (E420), xylitol, maltitol (E965), polymeric polyols (e.g., polydextrose (E1200)), quillaia (E999), urea, aloe vera gel, alpha hydroxy acids (e.g., lactic acid), and honey among others. The humectant source for the present invention may be any source or blend available for human consumption. Humectants are well known by those skilled in the art and can be readily selected when preparing such products. Commercial humectants sources are readily available and known to one practicing in the art.

### Nutritional Supplements

Among the materials suitable for use in the practice of the present invention are nutritional supplements. Nutritional supplements may be added or combined with the compositions of the present invention. Among the nutritional supplements that may be used, but are not limited to, are those listed in the The Natural Medicines Comprehensive Database and DeBusk RM. A critical review of the literature on weight loss supplements. Integrative Medicine Consult 2001; 3:30-1, incorporated herein by reference. Among the nutritional supplements are those that are purported to increase energy expenditure including but not limited to Ephedra, Bitter orange, Guarana, Caffeine, Country mallow, Yerba mate. Among the nutritional supplements are those that are purported to modulate carbohydrate metabolism including but not limited to chromium, and ginseng. Among the nutritional supplements are those that are purported to increase satiety including but not limited to guar gum, glucomannan, psyllium, chia and raw cornstarch. Among the nutritional supplements are those that are purported to increase fat oxidation or reduce fat synthesis including but not limited to 1-carnitine, hydroxycitric acid, green tea, vitamin B5, licorice, conjugated linoleic acid, and pyruvate. Among the nutritional supplements are those that are purported to block dietary fat absorption including but not limited to chitosan. Among the nutritional supplements are those that are purported to increase water elimination, dandelion and cascara. Among the nutritional supplements are those that are purported to enhance mood including but not limited to St. John's wort. Among the nutritional supplements are those that provide omega3 fatty acids from sources such as but not limited to animal, plant or bacterial sources. Among the nutritional supplements are those that are purported to have unspecified activity such as but not limited to Laminaria, spirulina [also known as blue-green algae], guggul and apple cider vinegar.

The nutritional supplement source for the present invention may be any source or blend of sources available for human consumption. Nutritional supplements are well known by those skilled in the art and can be readily selected when preparing such products. Commercial sources of nutritional supplements are readily available and known to one practicing in the art.

### Other Food

In yet another embodiment of the present invention, the functional-gel compositions of this invention can incorporate and or be combined with one or more foods such as but not limited to dairy products, fruits, nuts, seeds, and vegetables, including pulp, pomace, extracts, juices, concentrates and derivatives of these foods.

### REFERENCES

The following references are incorporated by reference herein:
a. Kirkmeyer et al in Int J Obes Relat Metab Disord. 2000 September; 24(9):1167-75
b. Food Industries Manual edited by M. D. Ranken, Christopher G J Baker, R. C. Kill
c. Wiley Encyclopedia of Food Science and Technology Frederick J. Francis 2nd edition 1999
d. Confectionery and Chocolate Engineering: Principles and Applications Ferenc Mohos ISBN: 978-1-4051-9470-9 712 pages September 2010, Wiley-Blackwell
e. Professor Ferenc Mohos is Managing Director of Food Quality 1992 Ltd, Budapest, Hungary.
f. Food Processing Technology: Principles and Practice, Second Edition, Parts 1-4 By P. J. Fellows
g. Oral Controlled Release Formulation Design and Drug Delivery: Theory to Practice edited by Hong Wen, Kinam Park, October 2010, Wiley Press.
h. Food Stabilizers, Thickeners and Gelling Agents, Alan Imeson, Aug. 24, 2014 John Wiley & Sons.
i. Food Texture and Viscosity: Concept and Measurement, 2^{nd} edition. by Malcolm Bourne • Elsevier Science • Academic Press
j. Gelatin Handbook: Theory and Industrial Practise, June 2007 Reinhard Schrieber, Herbert Gareis, Wiley-VCH.
k. Gelatin Handbook, Gelatin Manufacturers Institute of America, 2021 http://www.gelatin-gmia.com/images/GMIA_Gelatin_Manual_2012.pdf
l. Dietary Reference Intakes for Energy, Carbohydrate, Fiber, Fat, Fatty Acids, Cholesterol, Protein, and Amino Acids (Macronutrients) (2005)/7 Dietary, Functional, and Total Fiber. National Academic Press.
m. Food Gels: Gelling Process and New Applications Soumya Banerjee a & Suvendu Bhattacharya a Food Engineering Department, Central Food Technological Research Institute, (Council of Scientific and Industrial Research), Mysore, 570020, India Accepted author version posted online: 17 Jun. 2011. Published online: 14 Feb. 2012.
n. Opinion on Dietary Reference Values for protein1 EFSA Panel on Dietetic Products, Nutrition and Allergies (NDA)2, 3, European Food Safety Authority (EFSA), Parma, Italy, EFSA Journal 2012; 10(2):2557

That which is claimed:

1. A method of promoting satiety in a subject in need thereof, comprising the step of providing the subject with a sufficient amount of a food composition for consumption in association with a diet, meal or snack to promote satiety, where the food composition comprises:
a. an edible gelling agent;
b. a dietary protein;
c. optionally a dietary fiber, and;
d. water,
having a energy density of between 0.1-3.4 kcal/g

2. A method of promoting satiety in a subject in need thereof, comprising the step of providing the subject with a sufficient amount of a food composition for consumption in association with a diet, meal or snack to promote satiety, where the food composition comprises:
a. an edible gelling agent;
b. a dietary fiber;
c. optionally a dietary protein, and;
d. water,
having a energy density of between 0-3.4 kcal/g

3. A method according to claims 1 and 2, wherein the said method and said composition are further used to promote weight loss.

4. A method according to claims 1 and 2, wherein the said method and said composition are further used to prevent or treat overweight and obesity.

5. The method according to claims 1 and 2, wherein the gelling agent of the composition is one or a combination of: gelatin, kappa carageenan, iota carageenan, agar, locust bean gum, methylcellulose, sodium alginate, pectin, gellan gum, psyllium seek husk, glucomannan and starches.

6. A method according to claims 1 and 2 wherein said food composition further comprises a sweetener, a flavoring, an acidifier and colorant.

7. A method according to claims 1 and 2, wherein said food composition has a pH of between 3.0 and 5.

8. A method according to claims 1 and 2, wherein said food composition is processed and packaged as a shelf stable product.

9. A method according to claim 1 and 2, wherein said food composition is processed and packaged as a refrigerated product.

10. A method according to claims 1 and 2, wherein said food composition is in the form of a gummy confection, snack bar, nutrition bar, pudding, cookie, wafer, milkshake or gel.

11. A method according to claims 1 and 2, wherein said food composition is in the from of a meal replacement mix, meal replacement beverage, or meal replacement bar.
